(19) United States
(12) Patent Application Publication
(10) Pub. No.: US 2023/0243917 A1
(43) Pub. Date: Aug. 3, 2023

(54) INFORMATION PROCESSING DEVICE, USER TERMINAL, CONTROL METHOD, NON-TRANSITORY COMPUTER-READABLE MEDIUM, AND INFORMATION PROCESSING SYSTEM

(71) Applicant: NEC Corporation, Minato-ku, Tokyo (JP)

(72) Inventors: Yuji NAKAJIMA, Tokyo (JP); Toshikazu MARUYAMA, Tokyo (JP); Shizuko KANEGAE, Tokyo (JP); Takeomi MURAGISHI, Tokyo (JP)

(73) Assignee: NEC Corporation, Minato-ku, Tokyo (JP)

(21) Appl. No.: 18/023,796

(22) PCT Filed: Sep. 30, 2020
(86) PCT No.: PCT/JP2020/037232

§ 371 Date: Feb. 28, 2023

(51) Int. Cl. G01S 5/22; H04R 1/40

(52) U.S. Cl. CPC G01S 5/22; H04R 1/406

(57) ABSTRACT

An information processing device (1) includes receiving means (2) configured to receive audio information, first position information of a first user terminal, and first direction information of the first user terminal from the first user terminal, and receive second position information of a second user terminal and second direction information of the second user terminal from the second user terminal. The information processing device (1) further includes output means (3) configured to output the audio information, if a first position indicated by the first position information and a second position indicated by the second position information are within a predetermined distance, and if the second direction information is similar to the first direction information.

### TECHNICAL FIELD

The present disclosure relates to information processing devices, user terminals, control methods, non-transitory computer-readable media, and information processing systems.

### BACKGROUND ART

According to the disclosure of Patent Literature 1, audio data that sounds as if audio information is coming from the direction of a destination is generated based on the position information of a user, the orientation of the user's head, and the position information of the destination, and this generated audio data is output to the user.

### CITATION LIST

### Patent Literature

Patent Literature 1: Japanese Patent No. 6559921

### SUMMARY OF INVENTION

### Technical Problem

With the sophistication of information communication services, an audio service is contemplated in which a first user virtually installs audio information to a position that the first user specifies and, when a second user gets to this position, the installed audio information is output to the second user. Hoping to share information with other users, the first user may, for example, leave, in the form of audio information, a comment regarding the look of houses on a street, some scenery, a store, an exhibit, a piece of architecture, a popular spot, or the like. Then, upon listening to this audio information of the first user, the second user can sympathize with the first user's comment or gain new information from the first user's comment.

However, if the audio information is output to the second user while the situation in which the second user listens to the audio information differs from the situation in which the first user has generated the audio information, the second user may not be able to understand what the content of the first user's audio information indicates. Therefore, without consideration on the situation in which a first user generates audio information and the situation in which a second user listens to the audio information, the second user may not be able to sympathize with the audio information of the first user or to acquire new information, and thus implementation of an effective audio service may fail.

One object of the present disclosure is to provide an information processing device, a user terminal, a control method, a non-transitory computer-readable medium, and an information processing system that each make it possible to register audio information in such a manner that a user can listen to the audio at a position and a timing optimal in accordance with the user's situation.

### Solution to Problem

An information processing device according to the present disclosure includes:

receiving means configured to receive audio information, first position information of a first user terminal, and first direction information of the first user terminal from the first user terminal, and receive second position information of a second user terminal and second direction information of the second user terminal from the second user terminal; and

output means configured to output the audio information, if a first position indicated by the first position information and a second position indicated by the second position information are within a predetermined distance, and if the second direction information is similar to the first direction information.

A user terminal according to the present disclosure is configured to:

acquire audio information and position information of the user terminal; and

in response to receiving a registration instruction for the audio information, transmit the acquired audio information, the acquired position information, and the acquired direction information to an information processing device.

A control method according to the present disclosure includes:

receiving audio information, first position information of a first user terminal, and first direction information of the first user terminal from the first user terminal;

receiving second position information of a second user terminal and second direction information of the second user terminal from the second user terminal; and

outputting the audio information based on the first position information, the second position information, and the second direction information, if a first position indicated by the first position information and a second position indicated by the second position information are within a predetermined distance, and if the second direction information is similar to the first direction information.

A non-transitory computer-readable medium according to the present disclosure is a non-transitory computer-readable medium storing a control program that causes a computer to execute the processes of:

receiving audio information, first position information of a first user terminal, and first direction information of the first user terminal from the first user terminal;

receiving second position information of a second user terminal and second direction information of the second user terminal from the second user terminal; and

outputting the audio information, if a first position indicated by the first position information and a second position indicated by the second position information are within a predetermined distance, and if the second direction information is similar to the first direction information.

An information processing system according to the present disclosure includes:

a first user terminal;

a second user terminal; and

a server device configured to communicate with the first user terminal and the second user terminal, wherein

the first user terminal is configured to acquire audio information, first position information of the first user terminal, and first direction information of the first user terminal,

the second user terminal is configured to acquire second position information of the second user terminal and second direction information of the second user terminal, and

the server device is configured to
receive the audio information, the first position information, and the first direction information from the first user terminal,
receive the second position information and the second direction information from the second user terminal, and
output the audio information, if a first position indicated by the first position information and a second position indicated by the second position information are within a predetermined distance, and if the second direction information is similar to the first direction information.

### Advantageous Effects of Invention

The present disclosure can provide an information processing device, a user terminal, a control method, a non-transitory computer-readable medium, and an information processing system that each make it possible to register audio information in such a manner that a user can listen to the audio at a position and a timing optimal in accordance with the user's situation.

### BRIEF DESCRIPTION OF DRAWINGS

FIG. 1 illustrates a configuration example of an information processing device according to a first example embodiment.

FIG. 2 is a flowchart illustrating an operation example of the information processing device according to the first example embodiment.

FIG. 3 is an illustration for describing an outline of a second example embodiment.

FIG. 4 illustrates a configuration example of an information processing system according to the second example embodiment.

FIG. 5 is an illustration for describing a determination process that an output unit performs.

FIG. 6 is a flowchart illustrating an operation example of a server device according to the second example embodiment.

FIG. 7 illustrates a configuration example of an information processing system according to a third example embodiment.

FIG. 8 is a flowchart illustrating an operation example of a server device according to the third example embodiment.

FIG. 9 illustrates a configuration example of an information processing system according to a fourth example embodiment.

FIG. 10 illustrates a configuration example of an information processing system according to a fifth example embodiment.

FIG. 11 is a flowchart illustrating an operation example of a server device according to the fifth example embodiment.

FIG. 12 is a flowchart illustrating the operation example of the server device according to the fifth example embodiment.

FIG. 13 illustrates an example of how installation position information is displayed.

FIG. 14 illustrates another example of how installation position information is displayed.

FIG. 15 is an illustration for describing an outline of a sixth example embodiment.

FIG. 16 illustrates a configuration example of an information processing system according to the sixth example embodiment.

FIG. 17 is a flowchart illustrating an operation example of a server device according to the sixth example embodiment.

FIG. 18 illustrates a hardware configuration example of an information processing device and so on according to the example embodiments.

### EXAMPLE EMBODIMENT

Hereinafter, some example embodiments of the present disclosure will be described with reference to the drawings. In the following description and the drawings, omissions and simplifications are made, as appropriate, to make the description clearer. In the drawings referred to below, identical elements are given identical reference characters, and their repetitive description will be omitted, as necessary.

### First Example Embodiment

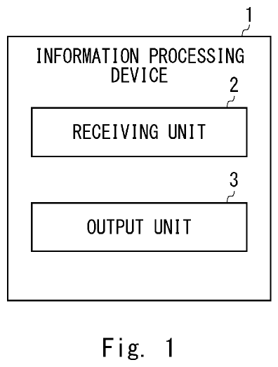

A configuration example of an information processing device 1 according to a first example embodiment will be described with reference to FIG. 1. FIG. 1 illustrates a configuration example of the information processing device according to the first example embodiment. The information processing device 1 is, for example, a server device. The information processing device 1 communicates with a first user terminal (not illustrated) that a first user uses and a second user terminal (not illustrated) that a second user uses. Herein, the first user terminal and the second user terminal may each be configured to include at least one communication terminal.

The information processing device 1 includes a receiving unit 2 and an output unit 3.

The receiving unit 2 receives audio information, first position information of the first user terminal, and first direction information of the first user terminal from the first user terminal. The receiving unit 2 receives second position information of the second user terminal and second direction information of the second user terminal from the second user terminal.

The audio information is, for example, audio content that the first user has recorded and that is installed virtually to a position indicated by the first position information. The first position information may be used as position information of the first user, and the second position information may be used as position information of the second user. The first direction information may be used as direction information of the first user, and the second direction information may be used as direction information of the second user. The first direction information may be information that indicates the facial direction in which the first user's face is pointing, and the second direction information may be information that indicates the facial direction in which the second user's face is pointing. Herein, the first direction information and the second direction information may include, respectively, the first user's posture information and the second user's posture information.

The output unit 3 outputs the audio information that the receiving unit 2 has received, if a first position indicated by the first position information and a second position indicated by the second position information are within a predetermined distance, and if the second direction information is similar to the first direction information. The output unit 3 outputs the audio information that the receiving unit 2 has received to at least one of a control unit (not illustrated) of the information processing device 1 or the second user terminal (not illustrated). The predetermined distance may be, for example, any distance of from 0 m to 10 m. The second direction information may be regarded to be similar to the first direction information if the angle formed by the direction indicated by the first direction information and the direction indicated by the second direction information is, for example, within 30°. Alternatively, the second direction information may be regarded to be similar to the first direction information if the angle formed by the direction indicated by the first direction information and the direction indicated by the second direction information is, for example, within 60°.

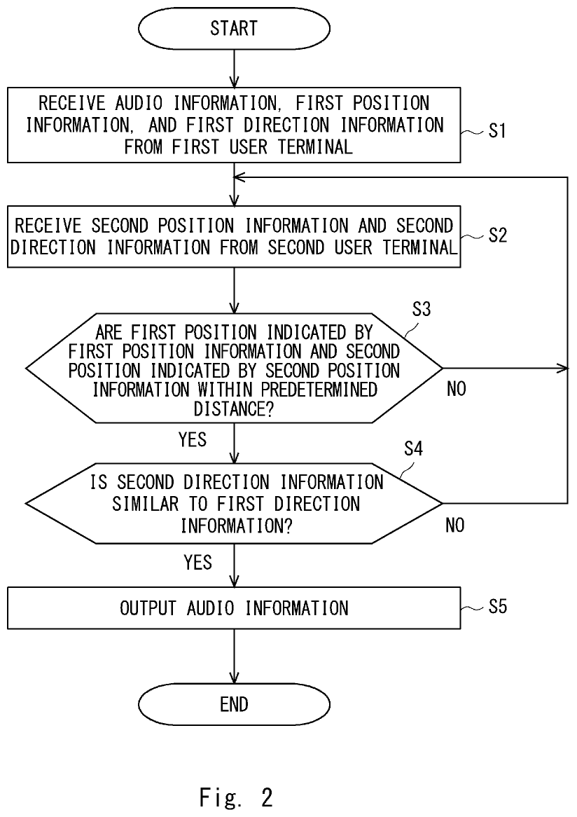

Next, an operation example of the information processing device 1 according to the first example embodiment will be described with reference to FIG. 2. FIG. 2 is a flowchart illustrating an operation example of the information processing device according to the first example embodiment.

The receiving unit 2 receives audio information, first position information of the first user terminal, and first direction information of the first user terminal from the first user terminal (step S1).

The receiving unit 2 receives second position information of the second user terminal and second direction information of the second user terminal from the second user terminal (step S2).

The output unit 3 determines whether a first position indicated by the first position information and a second position indicated by the second position information are within a predetermined distance (step S3).

If the first position and the second position are within the predetermined distance (YES at step S3), the output unit 3 determines that the second direction information is similar to the first direction information (step S4).

If the second direction information is similar to the first direction information (YES at step S4), the output unit 3 outputs the audio information that the receiving unit 2 has received to at least one of a control unit (not illustrated) of the information processing device 1 or the second user terminal (not illustrated) (step S5).

Meanwhile, if the first position and the second position are not within the predetermined distance (NO at step S3), or if the second direction information is not similar to the first direction information (NO at step S4), the information processing device 1 returns to step S2 and executes step S2 and the steps thereafter.

As described above, the receiving unit 2 receives the first position information, the first direction information, the second position information, and the second direction information. The output unit 3 outputs the audio information if the first position indicated by the first position information and the second position indicated by the second position information are within a predetermined distance, and if the second direction information is similar to the first direction information. To rephrase, the output unit 3 determines whether the situation that the second user who uses the second user terminal is in is similar to the situation that the first user who uses the first user terminal was in when the first user registered the audio information, based on the position and the direction of the first user terminal and the position and the direction of the second user terminal. If the output unit 3 has determined that the situation of the first user and the situation of the second user are similar, the output unit 3 outputs the audio information. In other words, the information processing device 1 allows the audio information to be output to the second user terminal if the information processing device 1 has determined that the situation of the first user and the situation of the second user are similar. Accordingly, the information processing device 1 according to the first example embodiment makes it possible to register audio information in such a manner that the user can listen to the audio at a position and a timing optimal in accordance with the user's situation.

### Second Example Embodiment

Next, a second example embodiment will be described. The second example embodiment is an example embodiment that embodies the first example embodiment more specifically. Prior to describing the details of the second example embodiment, an outline of the second example embodiment will be described.

### <Outline>

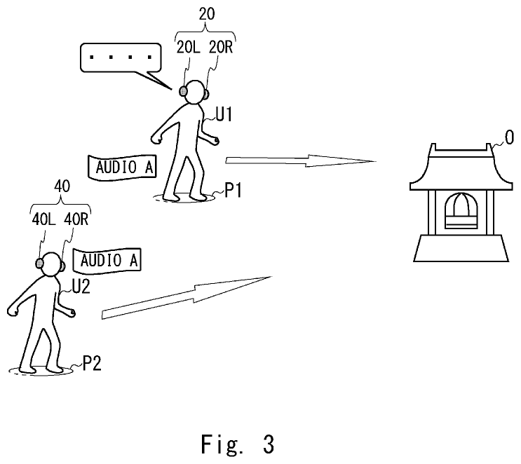

FIG. 3 is an illustration for describing an outline of the second example embodiment. FIG. 3 is a schematic diagram schematically illustrating an audio service in which a user U1 installs audio information in such a manner that those who have entered a region centered around the position of the user U1 can listen to the audio information and in which the audio information that the user U1 has installed is output to a user U2 upon the user U2 reaching the vicinity of the position of the user U1. In such an audio service, the user U1, for example, records his or her feelings, opinions, supplementary information, or the like concerning an object O, such as a piece of architecture, while facing the object O from a position P1. Then, the audio information (audio A) that the user U1 has recorded is installed in such a manner that people can listen to the audio information (audio A) upon reaching the vicinity of the position P1. The audio information (audio A) is output to the user U2 when the user U2 has reached a position P2, a position in the vicinity of the position of the position P1. Since the user U2 can listen to the audio information (audio A) that the user U1 has recorded concerning the object O, the user U2 can sympathize with the feelings and opinions that user U1 has on the object O, or the user U2 can obtain new information about the object O.

In FIG. 3, like the user U1, the user U2 is facing the direction of the object O. Therefore, when the audio information of the user U1 is audio information regarding the object O, the user U2, by listening to the audio information, can understand that the content of the audio information concerns the object O. However, it is also conceivable that the user U2 is, for example, at a position far from the position P1 or is, for example, facing a direction different from the direction that the user U1 faces. In such cases, since the object O is not located in the direction that the user U2 faces, the user U2, even after listening to the audio information that the user U1 has recorded, may not be able to understand what that audio information pertains to. In this manner, a lack of consideration on the situation of the user U1 and of the user U2 can make the audio information that the user U2 listens to less effective on the user U2, and thus an effective audio service cannot be provided to users.

Accordingly, the present example embodiment achieves a configuration capable of outputting effective audio information to a user U2 with the situation of a user U1 and of the user U2 taken into consideration. Specifically, the present example embodiment achieves a configuration in which, with the positions of the user U1 and the user U2 and the directions that the user U1 and the user U2 face taken into consideration, audio information is output if, for example, the user U2 is presumed to be looking at the same object that the user U1 is looking at.

Although the details will be described later, according to the present example embodiment, the user U1 wears a communication terminal 20 that is, for example, a hearable device and that includes, for example, a left unit 20L to be worn on the left ear and a right unit 20R to be worn on the right ear. Then, in response to an instruction from the user U1, the information processing system virtually installs audio information to the position P1 of the user U1 with use of the direction information of the user U1. The user U2, meanwhile, wears a communication terminal 40 that is, for example, a hearable device and that includes, for example, a left unit 40L to be worn on the left ear and a right unit 40R to be worn on the right ear. Then, the information processing system performs control of outputting the audio information to the user U2 when the user U2 has reached the position P2, a position in the vicinity of the position P1, if the direction that the user U2 is facing is similar to the direction that the user U1 was facing when the user U1 recorded the audio information. In FIG. 3, the user U1 and the user U2 each wear, for example, a hearable device. Yet, since it suffices that the communication terminals 20 and 40 can grasp the directions that, respectively, the users U1 and U2 face, the communication terminals 20 and 40 need not be hearable devices.

### <Configuration Example of Information Processing System>

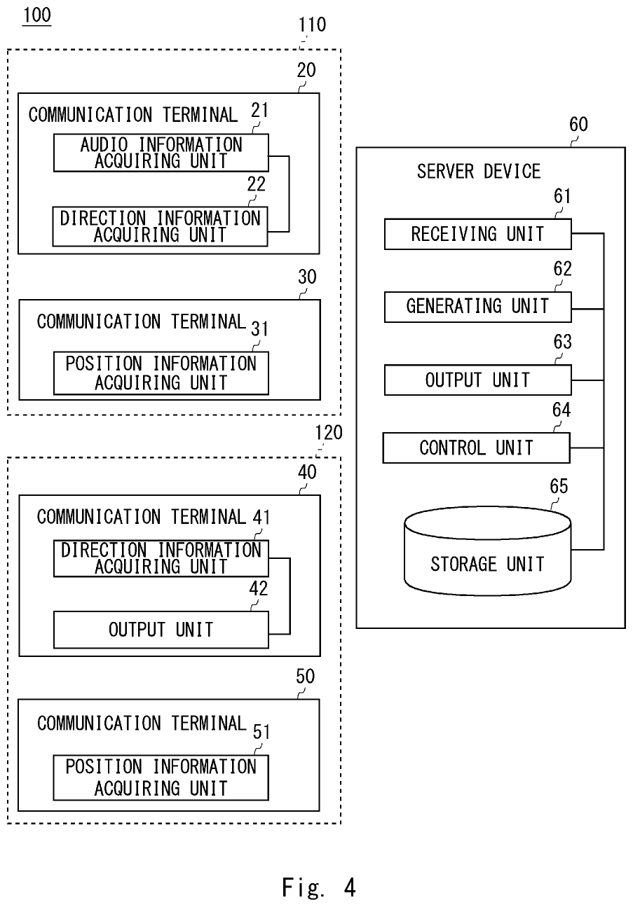

A configuration example of an information processing system 100 will be described with reference to FIG. 4. FIG. 4 illustrates a configuration example of the information processing system according to the second example embodiment.

The information processing system 100 includes a server device 60, a user terminal 110 to be used by the user U1, and a user terminal 120 to be used by the user U2. The user U1 and the user U2 may be different users or the same user. In a case where the user U1 and the user U2 are the same user, the user terminal 110 is configured to include the functions of the user terminal 120. In FIG. 4, the server device 60 is depicted as a device different from the user terminal 120. Alternatively, the server device 60 may be embedded into the user terminal 120, or the components of the server device 60 may be included in the user terminal 120.

The user terminal 110 is a communication terminal to be used by the user U1, and the user terminal 110 includes communication terminals 20 and 30. The user terminal 120 is a communication terminal to be used by the user U2, and the user terminal 120 includes communication terminals 40 and 50. The communication terminals 20 and 40 correspond to the communication terminals 20 and 40 shown in FIG. 3, and they are, for example, hearable devices. The communication terminals 30 and 50 are, for example, smartphone terminals, tablet terminals, mobile phones, or personal computer devices.

According to the present example embodiment, the user terminals 110 and 120 each include two communication terminals. Alternatively, the user terminals 110 and 120 may each be constituted by a single communication terminal. In this case, the user terminals 110 and 120 may each be, for example, a communication terminal in which two communication terminals are integrated into one unit, such as a head-mounted display. Alternatively, the communication terminal 30 may have the configuration of the communication terminal 20, and the communication terminal 50 may have the configuration of the communication terminal 40; and/or the communication terminal 20 may have the configuration of the communication terminal 30, and the communication terminal 40 may have the configuration of the communication terminal 50. Herein, in a case where the communication terminal 30 has the configuration of the communication terminal 20, the communication terminal 30 need not include a 9-axis sensor, since it suffices that the communication terminal 30 can acquire the direction information of the communication terminal 30. Similarly, in a case where the communication terminal 50 has the configuration of the communication terminal 40, the communication terminal 50 need not include a 9-axis sensor.

The communication terminal 20 is a communication terminal to be used by the user U1 and to be worn by the user U1. The communication terminal 20 is a communication terminal to be worn on the ears of the user U1, and the communication terminal 20 includes the left unit 20L to be worn on the left ear of the user U1 and the right unit 20R to be worn on the right ear of the user U1. Herein, the communication terminal 20 may be a communication terminal in which the left unit 20L and the right unit 20R are integrated into a unit.

The communication terminal 20 is a communication terminal capable of, for example, wireless communication that a communication service provider provides, and the communication terminal 20 communicates with the server device 60 via a network that a communication service provider provides. When the user U1 virtually installs audio information to the position of the user U1, the communication terminal 20 acquires the audio information. The audio information may be audio content that the user U1 has recorded or audio content held in the communication terminal 20. The communication terminal 20 transmits the acquired audio information to the server device 60. In this description, the communication terminal 20 (the left unit 20L and the right unit 20R) directly communicates with the server device 60. Alternatively, the communication terminal 20 (the left unit 20L and the right unit 20R) may communicate with the server device 60 via the communication terminal 30.

When the user U1 virtually installs audio information, the communication terminal 20 acquires the direction information of the communication terminal 20 and transmits the acquired direction information to the server device 60. The server device 60 treats the direction information of the communication terminal 20 as the direction information of the user terminal 110. The communication terminal 20 may regard the direction information of the communication terminal 20 as the direction information of the user U1.

The communication terminal 30 is a communication terminal to be used by the user U1. The communication terminal 30 connects to and communicates with the communication terminal 20, for example, via wireless communication using Bluetooth (registered trademark), Wi-Fi, or the like. Meanwhile, the communication terminal 30 communicates with the server device 60, for example, via a network that a communication service provider provides.

When the user U1 virtually installs audio information, the communication terminal 30 acquires the position information of the communication terminal 30 and transmits the acquired position information to the server device 60. The server device 60 treats the position information of the communication terminal 30 as the position information of the user terminal 110. The communication terminal 30 may regard the position information of the communication terminal 30 as the position information of the user U1. Herein, the communication terminal 30 may acquire the position information of the left unit 20L and of the right unit 20R based on the position information of the communication terminal 30 and the distance to the left unit 20L and the right unit 20R.

The communication terminal 40 is a communication terminal to be used by the user U2 and to be worn by the user U2. The communication terminal 40 is a communication terminal to be worn on the ears of the user U2, and the communication terminal 40 includes the left unit 40L to be worn on the left ear of the user U2 and the right unit 40R to be worn on the right ear of the user U2. Herein, the communication terminal 40 may be a communication terminal in which the left unit 40L and the right unit 40R are integrated into a unit.

The communication terminal 40 is a communication terminal capable of, for example, wireless communication that a communication service provider provides, and the communication terminal 40 communicates with the server device 60 via a network that a communication service provider provides. The communication terminal 40 acquires the direction information of the communication terminal 40 and transmits the acquired direction information to the server device 60. The server device 60 treats the direction information of the communication terminal 40 as the direction information of the user terminal 120. The communication terminal 40 may regard the direction information of the communication terminal 40 as the direction information of the user U2.

The communication terminal 40 outputs, to each of the user's ears, the audio information that the server device 60 outputs. In this description, the communication terminal 40 (the left unit 40L and the right unit 40R) directly communicates with the server device 60. Alternatively, the communication terminal 40 (the left unit 40L and the right unit 40R) may communicate with the server device 60 via the communication terminal 50.

The communication terminal 50 is a communication terminal to be used by the user U2. The communication terminal 50 connects to and communicates with the communication terminal 40, for example, via wireless communication using Bluetooth, Wi-Fi, or the like. Meanwhile, the communication terminal 50 communicates with the server device 60, for example, via a network that a communication service provider provides.

The communication terminal 50 acquires the position information of the communication terminal 50 and transmits the acquired position information to the server device 60. The server device 60 treats the position information of the communication terminal 50 as the position information of the user terminal 120. The communication terminal 50 may regard the position information of the communication terminal 50 as the position information of the user U2. Herein, the communication terminal 50 may acquire the position information of the left unit 40L and of the right unit 40R based on the position information of the communication terminal 50 and the distance to the left unit 40L and the right unit 40R.

The server device 60 corresponds to the information processing device 1 according to the first example embodiment. The server device 60 communicates with the communication terminals 20, 30, 40, and 50, for example, via a network that a communication service provider provides.

The server device 60 receives the position information of the user terminal 110 and the direction information of the user terminal 110 from the user terminal 110. The server device 60 receives audio information and the direction information of the communication terminal 20 from the communication terminal 20. The server device 60 receives the position information of the communication terminal 30 from the communication terminal 30.

The server device 60 generates region information that specifies a region with the position indicated by the position information of the user terminal 110 serving as a reference. The server device 60 registers, into the server device 60, the audio information received from the user terminal 110, the position information of the user terminal 110, and the region information with these pieces of information mapped together. A region is a region that is set virtually with the position information of the user terminal 110 serving as a reference, and this region may also be referred to as a geofence. Herein, the server device 60 may register the position information of the user terminal 110, the audio information, and the region information into a storage device external or internal to the server device 60. In the following description, a region may also be referred to as a geofence.

The server device 60 receives the position information of the user terminal 120 and the direction information of the user terminal 120 from the user terminal 120. The server device 60 receives the direction information of the communication terminal 40 from the communication terminal 40. The server device 60 receives the position information of the communication terminal 50 from the communication terminal 50.

If the position indicated by the position information of the user terminal 110 and the position indicated by the position information of the user terminal 120 are within a predetermined distance, and if the direction information of the user terminal 120 is similar to the direction information of the user terminal 110, the server device 60 outputs the audio information received from the communication terminal 20. The server device 60 performs control of outputting the audio information received from the communication terminal 20 to the left unit 40L and the right unit 40R of the communication terminal 40.

### <Configuration Example of Communication Terminal>

Next, a configuration example of the communication terminal 20 will be described. The communication terminal 20 includes an audio information acquiring unit 21 and a direction information acquiring unit 22. Since the communication terminal 20 includes the left unit 20L and the right unit 20R, the left unit 20L and the right unit 20R each include an audio information acquiring unit 21 and a direction information acquiring unit 22. The audio information that the user U1 utters and the direction that the user U1 faces are supposedly substantially identical in the left and right ears. Therefore, either one of the left unit 20L and the right unit 20R may include an audio information acquiring unit 21 and a direction information acquiring unit 22.

An audio information acquiring unit 21, for example, functions as an input unit, such as a microphone, as well and is configured to be capable of speech recognition. The audio information acquiring unit 21 receives an input of a registration instruction from the user U1 for registering audio information. The registration instruction for audio information is an instruction for registering audio information in such a manner that the audio information is installed virtually to the position of the user U1. When the user U1 records audio, the audio information acquiring unit 21 records the content uttered by the user U1 and generates the recorded content as audio information. In response to receiving, for example, an input of audio indicating a registration instruction for audio information from user U1, the audio information acquiring unit 21 transmits generated audio information to the server device 60. To rephrase, in response to receiving a registration instruction for audio information, the audio information acquiring unit 21 transmits audio information to the server device 60. Herein, if a registration instruction for audio information received from the user U1 includes information specifying certain audio information, the audio information acquiring unit 21 may acquire the specified audio information from audio information stored in the communication terminal 20 and transmit the acquired audio information to the server device 60.

A direction information acquiring unit 22 is configured to include, for example but not limited to, a 9-axis sensor (triaxial acceleration sensor, triaxial gyro sensor, and triaxial compass sensor). The direction information acquiring unit 22 acquires the direction information of the communication terminal 20 with the 9-axis sensor. The direction information acquiring unit 22 acquires the orientation that the communication terminal 20 faces. The orientation that the communication terminal 20 faces can be rephrased as information that indicates the facial direction that the face of the user is pointing. The direction information acquiring unit 22 generates the direction information of the communication terminal 20 that includes the acquired orientation. The direction information acquiring unit 22 may regard the direction information of the communication terminal 20 as the direction information of the user U1. In response to receiving, for example, an input of a registration instruction for audio information from the user U1, the direction information acquiring unit 22 acquires the direction information of the communication terminal 20 and transmits the acquired direction information of the communication terminal 20 to the server device 60. To rephrase, in response to receiving a registration instruction for audio information, the direction information acquiring unit 22 transmits the direction information to the server device 60.

Herein, in response to receiving a registration instruction for audio information, the direction information acquiring unit 22 may acquire the direction information of the communication terminal 20 based on an acquired result obtained by measuring the posture of the user U1 and may transmit the measurement result to the server device 60 along with the audio information. Specifically, the direction information acquiring unit 22 may measure the orientations in all three axial directions with use of the 9-axis sensor and acquire the direction information of the communication terminal 20 based on the measurement result in all three axial directions. Then, the direction information acquiring unit 22 may transmit, to the server device 60, the measurement result in all three axial directions including the acquired direction information, along with the audio information.

Since the direction information acquiring unit 22 includes the 9-axis sensor, the direction information acquiring unit 22 can acquire the posture of the user U1 as well. Therefore, the direction information may include posture information indicating the posture of the user U1. Since the direction information is data acquired by the 9-axis sensor, the direction information may also be referred to as sensing data.

Next, a configuration example of the communication terminal 30 will be described. The communication terminal 30 includes a position information acquiring unit 31.

The position information acquiring unit 31 is configured to include, for example, a global positioning system (GPS) receiver. The position information acquiring unit 31 receives GPS signals, acquires the latitude and longitude information of the communication terminal 30 based on the received GPS signals, and uses the acquired latitude and longitude information as the position information of the communication terminal 30. The position information acquiring unit 31 may regard the position information of the communication terminal 30 as the position information of the user U1. In response to, for example, a registration instruction for audio information being input from the user U1, the position information acquiring unit 31 receives this instruction from the communication terminal 20, acquires the position information of the communication terminal 30, and transmits the position information of the communication terminal 30 to the server device 60.

After a registration instruction for audio information is input by the user U1, the position information acquiring unit 31 may acquire the position information of the communication terminal 30 periodically and transmit the position information of the communication terminal 30 to the server device 60. When the user U1 records audio and when the audio information acquiring unit 21 generates audio information, the position information acquiring unit 31 acquires the position information held when the audio information has started being generated and the position information held when the audio information has finished being generated and transmits the acquired pieces of position information to the server device 60. In response to receiving a registration instruction for audio information, the position information acquiring unit 31 may transmit, to the server device 60, the position information of the communication terminal 30 held before the position information acquiring unit 31 has received the registration instruction or the position information of the communication terminal 30 held before and after the position information acquiring unit 31 has received the registration instruction.

Next, a configuration example of the communication terminal 40 will be described. The communication terminal 40 includes a direction information acquiring unit 41 and an output unit 42. Since the communication terminal 40 includes the left unit 40L and the right unit 40R, the left unit 40L and the right unit 40R may each include a direction information acquiring unit 41 and an output unit 42. The direction that the user U2 faces is supposedly substantially identical in the left and right ears. Therefore, either one of the left unit 40L and the right unit 40R may include a direction information acquiring unit 41.

A direction information acquiring unit 41 is configured to include, for example but not limited to, a 9-axis sensor (triaxial acceleration sensor, triaxial gyro sensor, and triaxial compass sensor). The direction information acquiring unit 41 acquires the direction information of the communication terminal 40 with the 9-axis sensor. The direction information acquiring unit 41 acquires the orientation that the communication terminal 40 faces. Since the communication terminal 40 is worn on the ears of the user U2, the orientation that the communication terminal 40 faces can be rephrased as information that indicates the facial direction that the face of the user U2 is pointing. The direction information acquiring unit 41 generates the direction information that includes the acquired orientation. The direction information acquiring unit 41 may regard the direction information of the communication terminal 40 as the direction information of the user U2. The direction information acquiring unit 41 acquires the direction information of the communication terminal 40 periodically or non-periodically. In response to acquiring the direction information of the communication terminal 40, the direction information acquiring unit 41 transmits the acquired direction information to the server device 60.

Since the direction information acquiring unit 41 includes the 9-axis sensor, the direction information acquiring unit 41 can acquire the posture of the user U2 as well. Therefore, the direction information may include posture information indicating the posture of the user U2. Since the direction information is data acquired by the 9-axis sensor, the direction information may also be referred to as sensing data.

The output unit 42 is configured to include, for example but not limited to, a stereo speaker. The output unit 42, functioning as a communication unit as well, receives audio information transmitted from the server device 60 and outputs the received audio information into the user's ears.

Next, a configuration example of the communication terminal 50 will be described. The communication terminal 50 includes a position information acquiring unit 51.

The position information acquiring unit 51 is configured to include, for example, a GPS receiver. The position information acquiring unit 51 receives GPS signals, acquires the latitude and longitude information of the communication terminal 50 based on the received GPS signals, and uses the acquired latitude and longitude information as the position information of the communication terminal 50. In response to acquiring the position information of the communication terminal 50, the position information acquiring unit 51 transmits the position information of the communication terminal 50 to the server device 60. The position information acquiring unit 51 acquires the position information of the communication terminal 50 periodically or non-periodically. The position information acquiring unit 51 transmits the acquired position information to the server device 60. The position information acquiring unit 51 may acquire the latitude and longitude information of the communication terminal 50 as the position information of the user U2.

### <Configuration Example of Server Device>

Next, a configuration example of the server device 60 will be described. The server device 60 includes a receiving unit 61, a generating unit 62, an output unit 63, a control unit 64, and a storage unit 65.

The receiving unit 61 corresponds to the receiving unit 2 according to the first example embodiment. The receiving unit 61 receives audio information, position information of the user terminal 110, and direction information of the user terminal 110 from the user terminal 110. Specifically, the receiving unit 61 receives audio information and direction information of the communication terminal 20 from the communication terminal 20 and receives position information of the communication terminal 30 from the communication terminal 30. The receiving unit 61 outputs the direction information of the communication terminal 20 to the generating unit 62 and the output unit 63 as the direction information of the user terminal 110. The receiving unit 61 outputs the position information of the communication terminal 30 to the generating unit 62 and the output unit 63 as the position information of the user terminal 110. The receiving unit 61 further receives a registration instruction for audio information from the communication terminal 20.

The receiving unit 61 receives position information of the user terminal 120 and direction information of the user terminal 120 from the user terminal 120. Specifically, the receiving unit 61 receives direction information of the communication terminal 40 from the communication terminal 40 and receives position information of the communication terminal 50 from the communication terminal 50. The receiving unit 61 outputs the direction information of the communication terminal 40 to the generating unit 62 as the direction information of the user terminal 120. The receiving unit 61 outputs the position information of the communication terminal 50 to the output unit 63 as the position information of the user terminal 120.

The generating unit 62 generates region information that specifies a region with the position indicated by the position information of the user terminal 110 serving as a reference. In response to receiving a registration instruction for audio information from the communication terminal 20, the generating unit 62 generates region information that specifies a geofence centered around the position indicated by the position information of the user terminal 110. The generating unit 62 registers the generated region information into the storage unit 65 with the region information mapped to the position information of the user terminal 110 and to the audio information.

A geofence may have any desired shape, such as a circular shape, a spherical shape, a rectangular shape, or a polygonal shape, and is specified based on region information. Region information may include, for example, the radius of a geofence when the geofence has a circular shape or a spherical shape. Meanwhile, when a geofence has a polygonal shape, including a rectangular shape, region information may include, for example, the distance from the center of the polygonal shape (the position indicated by the position information of the user terminal 110) to each vertex of the polygonal shape. In the following description, a geofence has a shape of a circle with its center set at the position indicated by the position information of the user terminal 110, and the region information indicates the radius of this circle. Since region information is information that specifies the size of a geofence, region information may be referred to as size information, as length information specifying a geofence, or as region distance information specifying a geofence.

The generating unit 62 generates a circular geofence having a predetermined radius. Herein, the radius of a geofence may be set as desired by the user U1. In response to receiving a registration instruction for audio information from the communication terminal 20, the generating unit 62 may determine a moving state of the user terminal 110 based on the amount of change in the position information of the user terminal 110 and may adjust the generated region information based on the determined moving state. Herein, the generating unit 62 may be configured not to adjust the generated region information based on the moving state.

The generating unit 62 calculates the amount of change per unit time in the position information of the user terminal 110 that the receiving unit 61 receives periodically. Based on the calculated amount of change, the generating unit 62 determines the moving state of the user terminal 110 by, for example, comparing the calculated amount of change against a moving state determination threshold.

The moving state includes a stationary state, a walking information, and a running state. If the generating unit 62 has determined that the moving state of the user terminal 110 is a stationary state, the generating unit 62 may change the generated region information to region information specifying a geofence that is based on the position indicated by the position information of the user terminal 110. In this case, the geofence may be the position indicated by the position information of the user terminal 110, or with the width of the user U1 taken into consideration, the geofence may be a circle having a radius of 1 m with the position indicated by the position information of the user terminal 110 serving as a reference.

Meanwhile, if the generating unit 62 has determined that the moving state is a walking state, the generating unit 62 may change the generated region information to region information specifying a geofence that is based on the position information of the user terminal 110 held when the audio information has started being generated and the position information of the user terminal 110 held when the audio information has finished being generated. In a case where the generating unit 62 has determined that the moving state is a running state as well, the generating unit 62 may change the generated region information to region information specifying a geofence that is based on the position information of the user terminal 110 held when the audio information has started being generated and the position information of the user terminal 110 held when the audio information has finished being generated. If the generating unit 62 has changed the generated region information, the generating unit 62 updates the region information stored in the storage unit 65 to the changed region information.

The output unit 63 corresponds to the output unit 3 according to the first example embodiment. The output unit 63 determines whether the position indicated by the position information of the user terminal 110 and the position indicated by the position information of the user terminal 120 are within a predetermined distance and whether the direction information of the user terminal 120 is similar to the direction information of the user terminal 110.

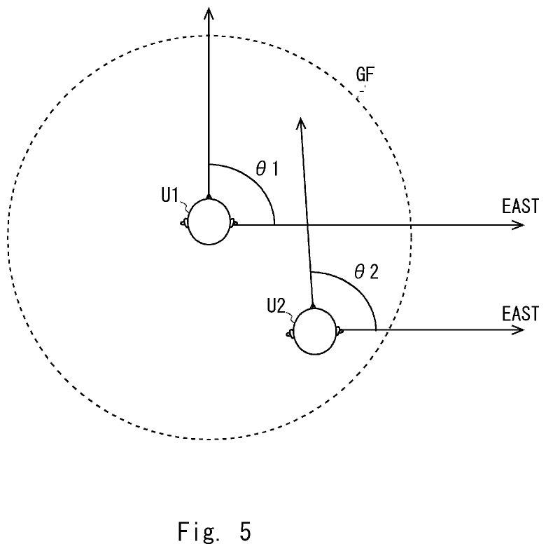

Now, a determination process that the output unit 63 performs will be described with reference to FIG. 5. FIG. 5 is an illustration for describing a determination process that the output unit performs. In FIG. 5, the dotted line represents a geofence GF specified by region information that the generating unit 62 has generated. The user U1 is at the position indicated by the position information of the user terminal 110, and the user U2 is at the position indicated by the position information of the user terminal 120.

If the position indicated by the position information of the user terminal 120 (the position of the user U2) is encompassed by the geofence GF, the output unit 63 determines that the position indicated by the position information of the user terminal 110 (the position of the user U1) and the position indicated by the position information of the user terminal 120 are within a predetermined distance.

If the position information of the user terminal 120 is encompassed by the region information, the output unit 63 determines that the position indicated by the position information of the user terminal 110 and the position indicated by the position information of the user terminal 120 are within a predetermined distance. In this manner, the output unit 63 determines whether the position indicated by the position information of the user terminal 110 (the position of the user U1) and the position indicated by the position information of the user terminal 120 (the position of the user U2) are within a predetermined distance with use of a geofence GF specified by region information.

Meanwhile, if the angle formed by the direction indicated by the direction information of the user terminal 110 and the direction indicated by the direction information of the user terminal 120 is within an angular threshold, the output unit 63 determines that the direction information of the user terminal 120 is similar to the direction information of the user terminal 110. The output unit 63 calculates an angle θ1 that indicates the angle formed by a reference direction and the direction indicated by the direction information of the user terminal 110. The reference direction is, for example, east. The output unit 63 calculates an angle θ2 that indicates the angle formed by this reference direction and the direction indicated by the direction information of the user terminal 120. Then, if the difference between the angle θ1 and the angle θ2 is no greater than an angular threshold, the output unit 63 determines that the direction information of the user terminal 120 is similar to the direction information of the user terminal 110. An angular threshold is a predetermined threshold and can be, for example but not limited to, 30° or 60°. Herein, an angular threshold may be adjustable as desired. In this manner, the output unit 63 determines whether the user U1 and the user U2 are looking at the same object, with use of the direction information of the user terminal 110, the direction information of the user terminal 120, and an angular threshold.

Referring back to FIG. 4, the description of the output unit 63 is continued. If the position indicated by the position information of the user terminal 110 and the position indicated by the position information of the user terminal 120 are within a predetermined distance, and if the direction information of the user terminal 120 is similar to the direction information of the user terminal 110, the output unit 63 outputs the audio information that the receiving unit 61 has received to the control unit 64.

The control unit 64, functioning as a communication unit as well, transmits the audio information output from the output unit 63 to each of the left unit 40L and the right unit 40R of the communication terminal 40.

The storage unit 65, in accordance with the control of the generating unit 62, stores audio information, the position information of the user terminal 110, and region information with these pieces of information mapped together. When the region information has been changed, the storage unit 65 updates this region information to the changed region information in accordance with the control of the generating unit 62.

### <Operation Example of Server Device>

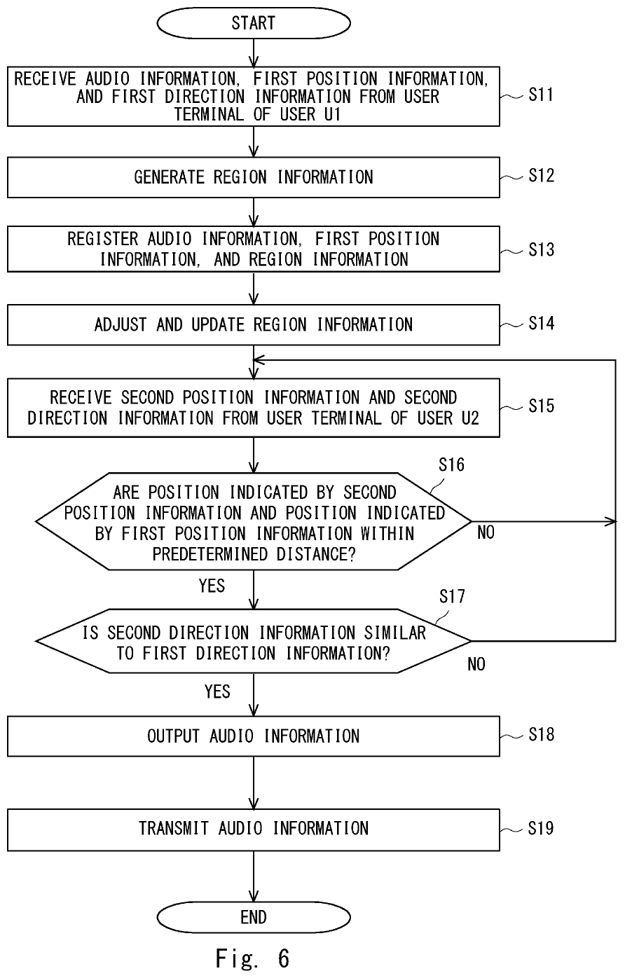

Next, an operation example of the server device 60 according to the second example embodiment will be described with reference to FIG. 6. FIG. 6 is a flowchart illustrating an operation example of the server device according to the second example embodiment. The flowchart shown in FIG. 6 roughly includes an audio information registration process executed at steps S11 to S13 and an audio information output process executed at steps S14 to S19. The audio information registration process is executed in response to a registration instruction for audio information being received from the user terminal 110. The audio information output process is executed repeatedly each time the server device 60 acquires position information and direction information of the user terminal 120.

For the sake of facilitating description, the position information of the user terminal 110 is referred to as first position information, and the direction information of the user terminal 110 is referred to as first direction information. Meanwhile, the position information of the user terminal 120 is referred to as second position information, and the direction information of the user terminal 120 is referred to as second direction information.

The receiving unit 61 receives audio information, first position information, and first direction information from the user terminal 110 of the user U1 (step S11). The receiving unit 61 receives the audio information and the direction information of the communication terminal 20 from the communication terminal 20 and receives the position information of the communication terminal 30 from the communication terminal 30. The receiving unit 61 outputs the direction information of the communication terminal 20 to the generating unit 62 and the output unit 63 as the direction information of the user terminal 110. The receiving unit 61 outputs the position information of the communication terminal 30 to the generating unit 62 and the output unit 63 as the position information of the user terminal 110.

The generating unit 62 generates region information that specifies a geofence with the position indicated by the first position information serving as a reference (step S12).

The generating unit 62 registers the audio information, the first position information, and the region information into the storage unit 65 with these pieces of information mapped together (step S13). The generating unit 62 registers the audio information received from the communication terminal 20, the position information of the user terminal 110, and the generated region information into the storage unit 65 with these pieces of information mapped together.

The generating unit 62 adjusts and updates the region information (step S14). The generating unit 62 determines the moving state of the user terminal 110 based on the amount of change in the position information of the user terminal 110 and adjusts the generated region information based on the determined moving state. The generating unit 62 calculates the amount of change per unit time in the position information of the user terminal 110 that the receiving unit 61 receives periodically. Based on the calculated amount of change, the generating unit 62 determines the moving state of the user terminal 110 by, for example, comparing the calculated amount of change against a moving state determination threshold. The generating unit 62 changes the region information in accordance with the determined moving state and updates the generated region information to the changed region information.

The receiving unit 61 receives second position information and second direction information from the user terminal 120 of the user U2 (step S15). The receiving unit 61 receives the direction information of the communication terminal 40 from the communication terminal 40 and receives the position information of the communication terminal 50 from the communication terminal 50. The receiving unit 61 outputs the direction information of the communication terminal 40 to the output unit 63 as the direction information of the user terminal 120. The receiving unit 61 outputs the position information of the communication terminal 50 to the output unit 63 as the position information of the user terminal 120.

The output unit 63 determines whether the position indicated by the first position information and the position indicated by the second position information are within a predetermined distance (step S16). The output unit 63 determines whether the second position information is encompassed by the region information. If the second position information is encompassed by the region information, the output unit 63 determines that the position indicated by the first position information and the position indicated by the second position information are within the predetermined distance.

If it has been determined that the position indicated by the first position information and the position indicated by the second position information are within the predetermined distance (YES at step S16), the output unit 63 determines whether the second direction information is similar to the first direction information (step S17). If the angle formed by the direction indicated by the first direction information and the direction indicated by the second direction information is within an angular threshold, the output unit 63 determines that the second direction information is similar to the first direction information. The output unit 63 calculates the angle θ1 that indicates the angle formed by a reference direction and the direction indicated by the first direction information. The output unit 63 calculates the angle θ2 that indicates the angle formed by the reference direction and the direction indicated by the second direction information. If the difference between the angle θ1 and the angle θ2 is no greater than the angular threshold, the output unit 63 determines that the second direction information is similar to the first direction information.

If it has been determined that the second direction information is similar to the first direction information (YES at step S17), the output unit 63 outputs the audio information that the receiving unit 61 has received to the control unit 64 (step S18).

Meanwhile, if it has been determined that the position indicated by the first position information and the position indicated by the second position information are not within the predetermined distance (NO at step S16), the server device 60 returns to step S15 and executes step S15 and the steps thereafter. Meanwhile, if it has been determined that the second direction information is not similar to the first direction information (NO at step S17), the server device 60 returns to step S15 and executes step S15 and the steps thereafter.

At step S19, the control unit 64 transmits the audio information to the user terminal 120 (step S19). The control unit 64, functioning as a communication unit as well, transmits the audio information to each of the left unit 40L and the right unit 40R of the communication terminal 40.

As described above, the receiving unit 61 receives the position information of the user terminal 110, the direction information of the user terminal 110, the position information of the user terminal 120, and the direction information of the user terminal 120. If the position indicated by the position information of the user terminal 110 and the position indicated by the position information of the user terminal 120 are within a predetermined distance, and if the direction information of the user terminal 120 is similar to the direction information of the user terminal 110, the output unit 63 outputs audio information. The control unit 64 outputs the audio information output thereto to each ear of the user U2 via the user terminal 120. Specifically, the output unit 63 performs a determination process with use of the position information and the direction information of the user terminal 110 and of the user terminal 120 and thus determines whether the situation that the user U2 is in when the user U2 listens to the audio information is similar to the situation that the user U1 was in when the user U1 generated the audio information. If the situation that the user U2 is in when the user U2 listens to the audio information is similar to the situation that the user U1 was in when the user U1 generated the audio information, the output unit 63 and the control unit 64 perform control of outputting the audio information to the user U2. Accordingly, the information processing system 100 according to the second example embodiment makes it possible to register and output audio information in such a manner that a user can listen to the audio at a position and a timing optimal in accordance with the user's situation. With this configuration, the user U2 can sympathize with the audio information that the user U1 has registered and can, moreover, acquire new information from the audio information that the user U1 has shared.

### Modification Example 1

According to the second example embodiment, the generating unit 62 determines the moving state of the user terminal 110 based on the position information of the user terminal 110. Alternatively, the server device 60 may receive speed information of the user terminal 110 and determine the moving state of the user terminal 110 based on the received speed information.

The communication terminal 20 is configured to include, for example but not limited to, a 9-axis sensor (triaxial acceleration sensor, triaxial gyro sensor, and triaxial compass sensor). Therefore, the communication terminal 20 can acquire the speed information of the communication terminal 20 with the 9-axis sensor. The communication terminal 20 acquires the speed information of the communication terminal 20 and transmits the acquired speed information to the server device 60. The receiving unit 61 receives the speed information from the communication terminal 20 and outputs the received speed information to the generating unit 62 as the speed information of the user terminal 110. Based on the speed information, the generating unit 62 may determine the moving state of the user terminal 110. Herein, as with the second example embodiment, the generating unit 62 may adjust the region information based on the determined moving state. In this manner, even when the second example embodiment is modified as in Modification Example 1, advantageous effects similar to those provided by the second example embodiment can be obtained. Herein, the second example embodiment and Modification Example 1 may be combined.

### Modification Example 2

A modification may be made such that the server device 60 according to the second example embodiment determines whether to cause the audio information to be output to the user U2 based attribute information of the user U1 and of the user U2.

In this case, the storage unit 65 stores the attribute information of the user U1 who uses the user terminal 110 and the attribute information of the user U2 who uses the user terminal 120. The attribute information may include, for example but not limited to, the user's gender, hobbies, or preferences.

The output unit 63 determines whether the position indicated by the position information of the user terminal 110 and the position indicated by the position information of the user terminal 120 are within a predetermined distance and whether the direction information of the user terminal 120 is similar to the direction information of the user terminal 110. If the position indicated by the position information of the user terminal 110 and the position indicated by the position information of the user terminal 120 are within the predetermined distance, and if the direction information of the user terminal 120 is similar to the direction information of the user terminal 110, the output unit 63 performs a determination process with use of the attribute information of the user U1 and of the user U2.

The output unit 63 acquires the attribute information of the user U1 and of the user U2 from the storage unit 65. If the attribute information includes, for example, the user's gender, hobbies, and preferences, and if the attribute information of the user U1 completely matches the attribute information of the user U2, the output unit 63 may output the audio information. Alternatively, the output unit 63 may output the audio information if at least one piece of the attribute information of the user U1 matches the attribute information of the user U2. With this configuration, the user U2 can sympathize with the audio information that the user U1 has registered and can acquire useful information suitable for the user U2 from the audio information that the user U1 has shared.

### Third Example Embodiment

Now, a third example embodiment will be described. A third example embodiment is an improvement example of the second example embodiment.

### <Configuration Example of Information Processing System>

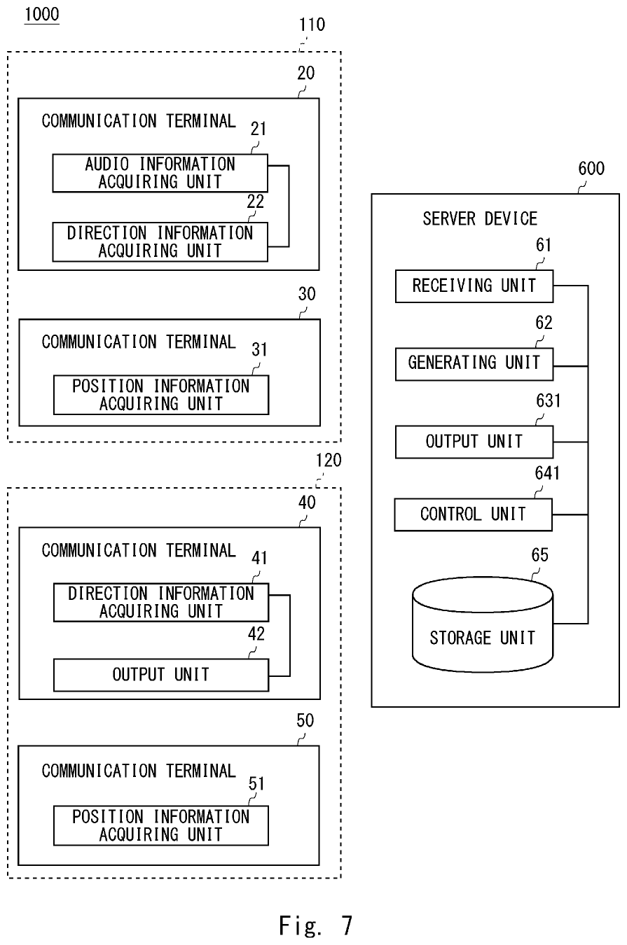

A configuration example of an information processing system 1000 according to the third example embodiment will be described with reference to FIG. 7. FIG. 7 illustrates a configuration example of the information processing system according to the third example embodiment. The information processing system 1000 includes a user terminal 110, a user terminal 120, and a server device 600. The user terminal 110 includes communication terminals 20 and 30. The user terminal 120 includes communication terminals 40 and 50.

The information processing system 1000 has a configuration in which the server device 60 according to the second example embodiment is replaced with the server device 600. Configuration examples and operation examples of the communication terminals 20, 30, 40, and 50 are basically similar to those according to the second example embodiment, and thus the following description will be provided with omissions, as appropriate.

### <Configuration Example of Server Device>

A configuration example of the server device 600 will be described. The server device 600 includes a receiving unit 61, a generating unit 62, an output unit 631, a control unit 641, and a storage unit 65. The server device 600 has a configuration in which the output unit 63 according to the second example embodiment is replaced with the output unit 631 and the control unit 64 according to the second example embodiment is replaced with the control unit 641. The receiving unit 61, the generating unit 62, and the storage unit 65 are basically similar to those according to the second example embodiment, and thus description thereof will be omitted, as appropriate.

As with the second example embodiment, the output unit 631 determines whether the position indicated by the position information of the user terminal 110 and the position indicated by the position information of the user terminal 120 are within a predetermined distance and whether the direction information of the user terminal 120 is similar to the direction information of the user terminal 110.

If the position indicated by the position information of the user terminal 110 and the position indicated by the position information of the user terminal 120 are within a predetermined distance, and if the direction information of the user terminal 120 is similar to the direction information of the user terminal 110, the output unit 631 generates sound localization information. The output unit 631 generates sound localization information with the position indicated by the position information of the user terminal 110 serving as a sound localization position.

The output unit 631 generates sound localization information with the position indicated by the position information of the user terminal 110 serving as a sound localization information, based on the position information of the user terminal 110, the position information of the user terminal 120, and the direction information of the user terminal 120.

Sound localization information is a parameter to be used to execute a sound localization process on audio information. To rephrase, sound localization information is a parameter used to make correction so that audio information can sound as audio coming from the position indicated by the position information of the user terminal 110 that serves as a sound localization position. To rephrase further, the output unit 631 generates sound localization information that is a parameter for making correction so that the audio information can sound as audio coming from the position of the user U1.

The output unit 631 generates left-ear sound localization information for the left unit 40L and right-ear sound localization information for the right unit 40R based on the position information of the user terminal 120, the direction information of the user terminal 120, and the position information of the user terminal 110. The output unit 631 outputs, to the control unit 641, sound localization information that includes the left-ear sound localization information and the right-ear sound localization information as well as the audio information that the receiving unit 61 has received.

The control unit 641 executes a sound localization process on audio information output thereto, based on the sound localization information that the output unit 631 has generated. To rephrase, the control unit 641 corrects acquired audio information based on the sound localization information. The control unit 641 generates left-ear audio information by correcting audio information based on left-ear sound localization information. The control unit 641 generates right-ear audio information by correcting audio information based on right-ear sound localization information.

The control unit 641, functioning as a communication unit as well, transmits the left-ear audio information and the right-ear audio information to, respectively, the left unit 40L and the right unit 40R of the communication terminal 40. Each time the output unit 631 generates sound localization information, the control unit 641 generates left-ear audio information and right-ear audio information based on the latest sound localization information and transmits the generated left-ear audio information and right-ear audio information to the left unit 40L and the right unit 40R, respectively. The control unit 641 performs controls of outputting the left-ear audio information and the right-ear audio information to the output unit 42 of the left unit 40L and of the right unit 40R of the communication terminal 40.

### <Configuration Example of Communication Terminal>

Next, a configuration example of the communication terminal 40 will be described in regard to its differences from the second example embodiment.

The output unit 42, functioning as a communication unit as well, receives audio information subjected to a sound localization process from the server device 600 and outputs the received audio information to the user's ears. If the output unit 42 has received audio information subjected to a sound localization process from the server device 600, the output unit 42 switches the audio information to be output from the audio information presently being output to the received audio information at a predetermined timing. The audio information subjected to the sound localization process includes left-ear audio information for the left unit 40L and right-ear audio information for the right unit 40R. The output unit 42 of the left unit 40L outputs the left-ear audio information, and the output unit 42 of the right unit 40R outputs the right-ear audio information.

### <Operation Example of Server Device>

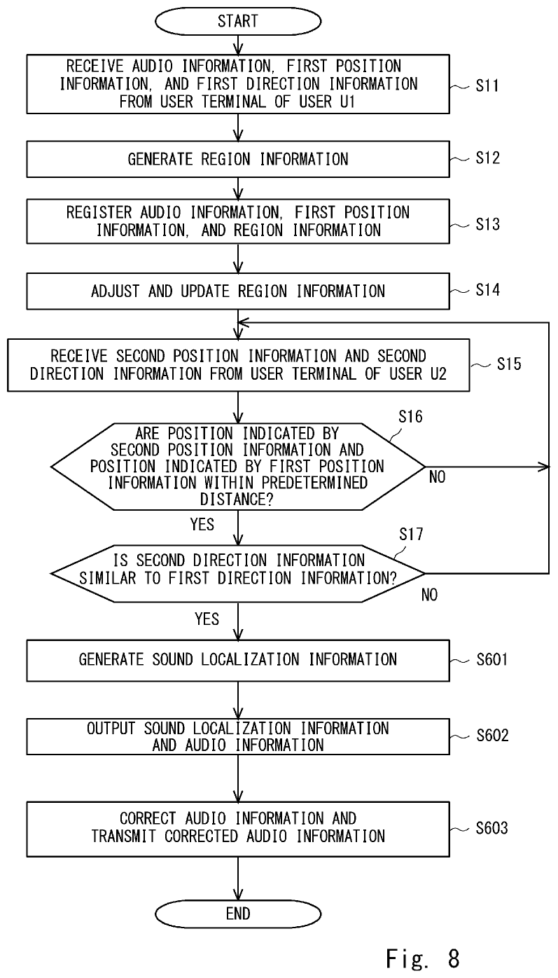

Next, an operation example of the server device 600 according to the third example embodiment will be described with reference to FIG. 8. FIG. 8 is a flowchart illustrating an operation example of the server device according to the third example embodiment. FIG. 8 corresponds to FIG. 6 but differs from FIG. 6 in the operations at step S18 and thereafter. Since the operations up to step S17 are similar to those in the flowchart shown in FIG. 6, description thereof will be omitted, as appropriate.

If it has been determined that the second direction information is similar to the first direction information (YES at step S17), the output unit 631 generates sound localization information with the position indicated by the first position information serving as a sound localization position, based on the first position information, the second position information, and the second direction information (step S601). The output unit 631 generates left-ear sound localization information for the left unit 40L and right-ear sound localization information for the right unit 40R based on the second position information, the second direction information, and the first position information.

At step S602, the output unit 631 outputs, to the control unit 641, the sound localization information that includes the left-ear sound localization information and the right-ear sound localization information as well as the audio information that the receiving unit 61 has received (step S602).

The control unit 641 corrects the audio information and transmits the corrected audio information to the user terminal 120 (step S603). The control unit 641 executes a sound localization process on the audio information to be output, based on the sound localization information that the output unit 631 has generated. The control unit 641 generates left-ear audio information by correcting the audio information based on the left-ear sound localization information. The control unit 641 generates right-ear audio information by correcting the audio information based on the right-ear sound localization information. The control unit 641, functioning as a communication unit as well, transmits the left-ear audio information and the right-ear audio information to, respectively, the left unit 40L and the right unit 40R of the communication terminal 40.

As described above, even when the second example embodiment is configured as in the third example embodiment, advantageous effects similar to those provided by the second example embodiment can be obtained. According to the present example embodiment, the output unit 631 generates sound localization information with the position indicated by the position information of the user terminal 110 serving as a sound localization position. The sound localization information that the output unit 631 generates is sound localization information in which the position of the user U1 serves as a sound localization position. Therefore, the user U2 can listen to the audio information that the user U1 has registered as if the user U1 is talking to the user U2. Accordingly, the information processing system 1000 according to the third example embodiment can output, to the user U2, audio information that sounds as if the user U1 is talking to the user U2, and can thus provide the user with an experience close to a meatspace experience.

### Fourth Example Embodiment

Next, a fourth example embodiment will be described. The fourth example embodiment is an improvement example of the second example embodiment and is a modification example of the third example embodiment. The fourth example embodiment will be described with reference to the third example embodiment. According to the third example embodiment, the server device 60 executes a sound localization process on audio information. According to the fourth example embodiment, a user terminal 120 executes a sound localization process on audio information. Since the fourth example embodiment includes configurations and operations similar to those according to the third example embodiment, description of such similar configurations and operations will be omitted, as appropriate.

### <Configuration Example of Information Processing System>

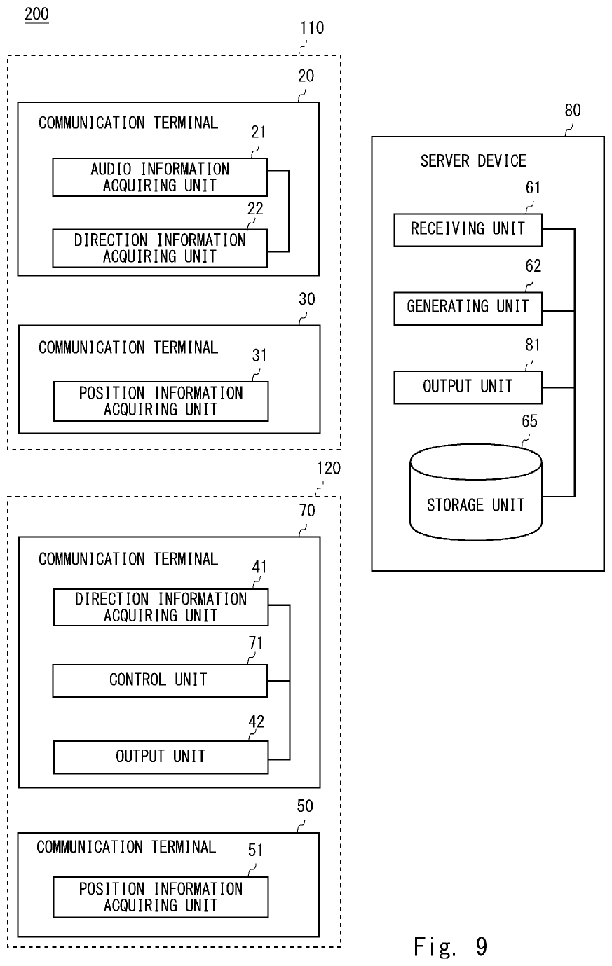

An information processing system 200 according to the fourth example embodiment will be described with reference to FIG. 9. FIG. 9 illustrates a configuration example of the information processing system according to the fourth example embodiment. The information processing system 200 includes a user terminal 110, a user terminal 120, and a server device 80. The user terminal 110 includes communication terminals 20 and 30. The user terminal 120 includes communication terminals 50 and 70.

The information processing system 200 has a configuration in which the communication terminal 40 according to the third example embodiment is replaced with the communication terminal 70 and the server device 60 is replaced with the server device 80. Configuration examples and operation examples of the communication terminals 20, 30, and 50 are similar to those according to the third example embodiment, and thus description thereof will be omitted, as appropriate.

### <Configuration Example of Communication Terminal>

Next, a configuration example of the communication terminal 70 will be described. The communication terminal 70 includes a direction information acquiring unit 41, a control unit 71, and an output unit 42. The communication terminal 70 has a configuration in which the control unit 71 is added to the configuration of the communication terminal 40 according to the third example embodiment. The configuration of the direction information acquiring unit 41 and the configuration of the output unit 42 are basically similar to those according to the third example embodiment, and thus description thereof will be omitted, as appropriate. According to the present example embodiment, the communication terminal 70 includes the control unit 71. Alternatively, the communication terminal 50 may include the control unit 71, and the communication terminal 70 may not include the control unit 71.

The control unit 71 communicates with the server device 80. The control unit 71 receives audio information and sound localization information from an output unit 81 of the server device 80. The control unit 71 executes a sound localization process on audio information based on sound localization information. To rephrase, the control unit 71 corrects audio information based on sound localization information.

As with the third example embodiment, sound localization information includes left-ear sound localization information and right-ear sound localization information. The control unit 71 generates left-ear audio information by correcting audio information based on left-ear sound localization information and generates right-ear audio information by correcting audio information based on right-ear sound localization information.

The control unit 71 outputs left-ear audio information and right-ear audio information to the output unit 42. Each time the control unit 71 receives sound localization information from the output unit 81, the control unit 71 generates left-ear audio information and right-ear audio information based on the latest sound localization information, and outputs the left-ear audio information and the right-ear audio information to the respective output units 42.

The output units 42 receive the audio information on which the control unit 71 has executed a sound localization process, and output the received audio information to the user's ears. The output unit 42 of the left unit 40L outputs left-ear audio information, and the output unit 42 of the right unit 40R outputs right-ear audio information. If the output units 42 have received audio information subjected to a sound localization process from the control unit 71, the output units 42 switch the audio information to be output from the audio information presently being output to the received audio information at a predetermined timing.

### <Configuration Example of Server Device>

Next, a configuration example of the server device 80 will be described. The server device 80 includes a receiving unit 61, a generating unit 62, the output unit 81, and a storage unit 65. The server device 80 has a configuration in which the server device 80 does not include the control unit 641 according to the third example embodiment and the output unit 631 is replaced with the output unit 81. The receiving unit 61, the generating unit 62, and the storage unit 65 have configurations basically similar to those according to the third example embodiment, and thus description thereof will be omitted, as appropriate.

The output unit 81, functioning as a communication unit as well, transmits (outputs) sound localization information that the output unit 81 has generated and that includes left-ear sound localization information and right-ear sound localization information to the control unit 71. The output unit 81 transmits sound localization information to the control unit 71 each time the output unit 81 generates sound localization information. The output unit 81 controls the control unit 71 such that the control unit 71 performs a sound localization process with use of the latest sound localization information.

The output unit 81 acquires, from the storage unit 65, audio information mapped to the sound localization position information used to generate sound localization information. The output unit 81 transmits (outputs) the acquired audio information to the control unit 71. Herein, when the output unit 81 has generated sound localization information, if the output unit 81 has already transmitted audio information to the control unit 71, the output unit 81 refrains from retransmitting the audio information to the control unit 71.

### <Operation Example of Information Processing System>

Next, an operation example of the information processing system 200 according to the fourth example embodiment will be described. The operation example of the information processing system 200 is basically similar to the operation example illustrated in FIG. 8, and thus the operation example will be described with reference to FIG. 8.

The operations from step S11 to step S17 and at step S601 are similar to those shown in FIG. 8, and thus description thereof will be omitted.

The output unit 81 outputs (transmits) the sound localization information to the control unit 71 (step S602). The output unit 81 transmits the generated sound localization information to the control unit 71. The output unit 81 acquires, from the storage unit 65, audio information mapped to the sound localization position information used to generate the sound localization information. The output unit 81 transmits (outputs) the acquired audio information to the control unit 71.

The control unit 71 corrects the audio information and transmits (outputs) the corrected audio information to the output unit 42 (step S603). The control unit 71 receives the audio information and the sound localization information from the output unit 81. The control unit 71 corrects the audio information based on the sound localization information and transmits (outputs) the corrected audio information to the output unit 42.

In this manner, even when the configuration of the third example embodiment is configured as in the fourth example embodiment, advantageous effects similar to those provided by the third example embodiment can be obtained. In the configuration according to the fourth example embodiment, a sound localization process on audio information is executed by the communication terminal 70. If the server device 80 performs a sound localization process on audio information to be output to all the communication terminals, as in the third example embodiment, the processing load of the server device 80 increases with an increase in the number of communication terminals. Therefore, additional server devices need to be provided depending on the number of communication terminals. In this respect, according to the fourth example embodiment, the server device 80 does not execute a sound localization process on audio information, and the communication terminal 70 instead executes a sound localization process. Therefore, the processing load of the server device 80 can be reduced, and the equipment cost that could be incurred for additional servers can be suppressed.

Furthermore, the configuration according to the fourth example embodiment can reduce the network load. According to the third example embodiment, corrected audio information needs to be transmitted each time sound localization information is updated. In contrast, according to the fourth example embodiment, if the output unit 81 has already transmitted audio information to the control unit 71, the output unit 81 refrains from retransmitting audio information and only needs to transmit sound localization information. Therefore, the configuration according to the fourth example embodiment can reduce the network load.

### Fifth Example Embodiment

A fifth example embodiment is an improvement example of the third and fourth example embodiments. Therefore, the fifth example embodiment will be described based on the third example embodiment in regard to its differences from the third example embodiment. According to the third and fourth example embodiments, the user U1 virtually installs audio information to the position of the user U1, and audio information corrected in such a manner that as if the user U1 utters the content of the audio information is output to the user U2. In recent years, an audio service is contemplated that provides a user with audio emitted from a personified object. With the example illustrated in FIG. 3, there may be such a desire that the user U1 virtually installs audio information not to the position of the user U1 but to an object O and the audio information is made audible to the user U2 as if the object O is talking to the user U2. In this manner, outputting audio information from a personified object makes it possible to provide a user with a virtual experience that he or she cannot experience in meatspace. The present example embodiment achieves a configuration in which a user U1 virtually installs audio information to an object O and the audio information is output from the object O.

### <Configuration Example of Information Processing System>

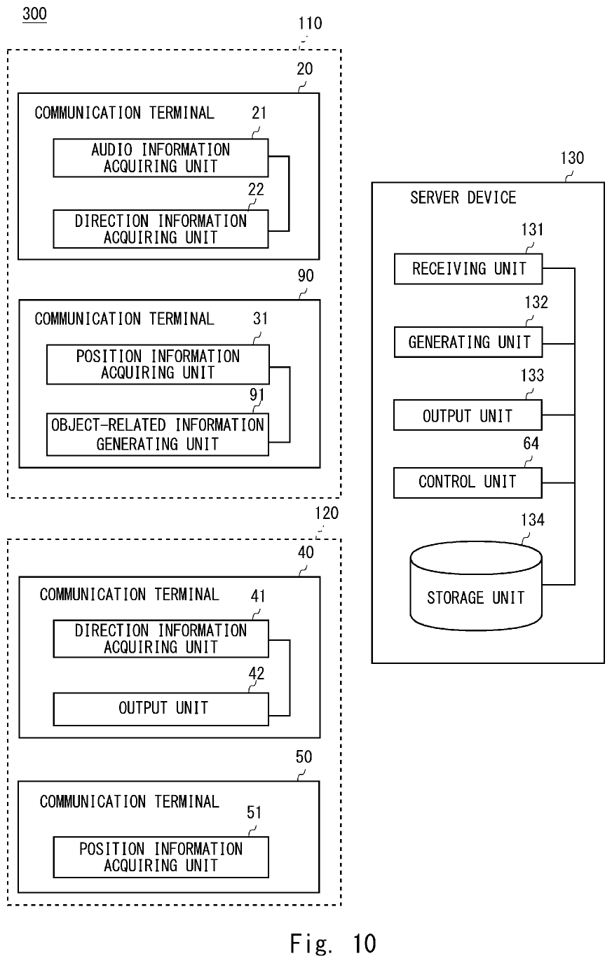

An information processing system 300 according to the fifth example embodiment will be described with reference to FIG. 10. FIG. 10 illustrates a configuration example of the information processing system according to the fifth example embodiment. The information processing system 300 includes a user terminal 110, a user terminal 120, and a server device 130. The user terminal 110 includes communication terminals 20 and 90. The user terminal 120 includes communication terminals 40 and 50.

The information processing system 300 has a configuration in which the communication terminal 30 according to the third example embodiment is replaced with the communication terminal 90 and the server device 60 is replaced with the server device 130. Configuration examples and operation examples of the communication terminals 20, 40, and 50 are basically similar to those according to the third example embodiment, and thus description thereof will be omitted, as appropriate.

### <Configuration Example of Communication Terminal>

Next, a configuration example of the communication terminal 20 will be described. An audio information acquiring unit 21 receives an input of a registration instruction for registering audio information from a user U1. According to the present example embodiment, a registration instruction for audio information is an instruction for registering audio information in such a manner that the audio information is installed virtually to a position specified by the user U1. Located at the position where the audio information is virtually installed is an object related to the audio information, and this position is determined in accordance with whether object position information indicating position information of this object is acquired.

Specifically, the position where the audio information is virtually installed is determined to the position of the user U1 if no object position information is acquired or is determined based on object position information if object position information is acquired. Herein, the user U1 may be able to select whether to designate the position where the audio information is to be installed virtually to the position of the user U1 or, if there is a position of an object related to the audio information, to this position of the object.

Next, a configuration example of the communication terminal 90 will be described. The communication terminal 90 includes a position information acquiring unit 31 and an object-related information generating unit 91. The communication terminal 90 has a configuration in which the object-related information generating unit 91 is added to the configuration of the communication terminal 30 according to the third example embodiment. The configuration of the position information acquiring unit 31 is basically similar to that according to the third example embodiment, and thus description thereof will be omitted, as appropriate. According to the present example embodiment, the communication terminal 90 includes the object-related information generating unit 91. Alternatively, the communication terminal 20 may include the object-related information generating unit 91, and the communication terminal 90 may not include the object-related information generating unit 91.

The object-related information generating unit 91 generates object information that indicates whether there is an object related to audio information. An object is an entity to which an acoustic image is localized, and examples of such objects include not only a building, a facility, or a store but also a variety of entities, including a sign, a signboard, a mannequin, a mascot doll, or an animal.

The object-related information generating unit 91 also functions, for example, as an input unit, such as a touch panel. If a registration instruction for audio information is input by the user U1, and when the object-related information generating unit 91 receives this registration instruction from the communication terminal 20, the object-related information generating unit 91 causes the user U1 to provide an input as to whether there is an object related to the audio information and generates object information based on the input information. If the input of the user U1 indicates that there is an object, the object-related information generating unit 91 generates object information indicating that there is an object related to the audio information. If the input of the user U1 indicates that there is no object, the object-related information generating unit 91 generates object information indicating that there is no object related to the audio information.

Alternatively, the object-related information generating unit 91 may cause the user U1 to provide an input indicating whether audio information is related to an object or the user U1 is talking to himself or herself, and the object-related information generating unit 91 may generate object information based on the input information. If the input of the user U1 indicates that the audio information is related to an object, the object-related information generating unit 91 generates object information indicating that there is an object related to the audio information. If the input of the user U1 indicates that the audio information is what the user U1 is talking to himself or herself, the object-related information generating unit 91 generates object information indicating that there is no object related to the audio information.

Alternatively, the object-related information generating unit 91 may, for example, include a microphone and be configured to be capable of speech recognition, and the object-related information generating unit 91 may generate object information based on the speech of the user U1. In response to receiving a registration instruction for audio information from the communication terminal 20, the object-related information generating unit 91 enters a state in which the object-related information generating unit 91 can accept a voice input from the user U1. If the user U1 has uttered, for example, “there is an object” or “the object is an object O” to indicate that there is an object, the object-related information generating unit 91 may generate object information indicating that there is an object related to the audio information. If the user U1 has uttered, for example, “there is no object” to indicate that there is no object, or if the user U1 refrains from uttering anything indicative of the presence of an object within a predefined period, the object-related information generating unit 91 may generate object information indicating that there is no object related to the audio information.

If there is an object related to audio information, and if the audio information is installed virtually to this object, the object-related information generating unit 91 generates object position information indicating the position information of the object to which the audio information is virtually installed. Herein, if the object information indicates that there is no object related to the audio information, the object-related information generating unit 91 refrains from generating object position information.

The object-related information generating unit 91 also functions, for example, as an input unit, such as a touch panel. If the user U1 has provided an input indicating that there is an object related to audio information, the object-related information generating unit 91 causes the user U1 to input object position information indicating the position information of the object to which the audio information is to be virtually installed. The object-related information generating unit 91 may cause the user U1 to input, for example, the latitude and the longitude or may cause the user U1 to select a position on a map displayed on a touch panel. The object-related information generating unit 91 generates object position information based on the input latitude and longitude or based on the position selected on the map. If the user U1 does not input any latitude or longitude, or if the user U1 does not select any position on a map, the object-related information generating unit 91 refrains from generating object position information.

Alternatively, the object-related information generating unit 91 is configured to be capable of recognizing the speech uttered by the user U1 when the object-related information generating unit 91 has received an input indicating that there is an object related to audio information. If the user U1 has provided an utterance that allows the position of an object to be identified, the object-related information generating unit 91 may generate object position information based on the utterance of the user U1. Alternatively, the object-related information generating unit 91 may store names of objects and object position information mapped to each other, and the object-related information generating unit 91 may identify object position information based on the name of an object that the user U1 has uttered and generate the identified object position information as the object position information. If the user U1 does not provide any utterance that allows the position of an object to be identified within a predefined period, the object-related information generating unit 91 refrains from generating object position information.

Alternatively, the object-related information generating unit 91 may be configured to include, for example, a camera. The object-related information generating unit 91 may analyze an image captured by the user U1, identify the object, identify the position information of the object, and generate the object position information based on the identified position information. If the user U1 captures no image, the object-related information generating unit 91 refrains from generating object position information. Herein, in a case where the communication terminal 30 is, for example, a communication terminal to be worn on the face of the user U1, the object-related information generating unit 91 may be configured to be capable of estimating the direction of the line of sight of the user U1. In this case, the object-related information generating unit 91 may identify an object and the position of the object based on an image that the user U1 has captured and the direction of the line of sight of the user U1, and may generate object position information based on the identified position.

Alternatively, the object-related information generating unit 91 may store position information of a plurality of objects and may generate, as object position information, the object position information identified from the position information of a stored object based on the direction information of the communication terminal 20 and the position information of the communication terminal 30. Alternatively, the object-related information generating unit 91 may store position information of an object and be configured to be capable of identifying the direction of the line of sight of the user, and the object-related information generating unit 91 may identify object position information with use of the direction information of the communication terminal 20, the position information of the communication terminal 30, and the direction of the line of sight of the user U1. Then, the object-related information generating unit 91 may generate the identified position information as the object position information. If the user U1 has provided an input indicating that the user U1 is not to set any object position information, the object-related information generating unit 91 discards the generated object position information.

The object-related information generating unit 91 transmits object information to the server device 60. If the object-related information generating unit 91 has generated object position information, the object-related information generating unit 91 transmits this object position information to the server device 60.

### <Configuration Example of Server Device>

Next, a configuration example of the server device 130 will be described. The server device 130 includes a receiving unit 131, a generating unit 132, an output unit 133, a control unit 64, and a storage unit 134. The server device 130 has a configuration in which the receiving unit 61, the generating unit 62, the output unit 63, and the storage unit 65 according to the third example embodiment are replaced with, respectively, the receiving unit 131, the generating unit 132, the output unit 133, and the storage unit 134. The configuration of the control unit 64 is basically similar to that according to the third example embodiment, and thus description thereof will be omitted, as appropriate.

The receiving unit 131 receives object information from the object-related information generating unit 91. If the object-related information generating unit 91 has transmitted object position information, the receiving unit 131 receives the object position information from the object-related information generating unit 91.

The generating unit 132 registers, into the storage unit 134, generated region information with this generated region information mapped to the position information of the user terminal 110, object information, object position information, and audio information. If the generating unit 132 receives no object position information, the generating unit 132 refrains from registering object position information into the storage unit 134.

As with the third example embodiment, the output unit 133 makes a determination based on an angle θ1 that indicates the angle formed by a reference direction and the direction indicated by the direction information of the user terminal 110 and an angle θ2 that indicates the angle formed by the reference direction and the direction indicated by the direction information of the user terminal 120.

With use of the object information that the receiving unit 131 has received, the output unit 133 sets an angular threshold to be used to make the determination based on the angle θ1 and the angle θ2 in accordance with whether there is an object related to audio information. The output unit 133 sets the angular threshold to a first angular threshold if object information indicates that there is an object related to audio information or sets the angular threshold to a second angular threshold greater than the first angular threshold if object information indicates that there is no object related to audio information. The output unit 133 may set the first angular threshold to, for example, 30° and may set the second angular threshold to any desired angle between, for example, 60° and 180°.

Even if there is an object related to audio information, if the user U2 is not facing the direction of the object, the user U2 may not be able to understand the content of the audio information related to the object. Therefore, if there is an object related to audio information, the output unit 133 sets the angular threshold to a relatively small value. Meanwhile, since there may be a case where, for example, the user U1 generates his or her feelings on some scenery in the form of audio information, if there is no object related to audio information, the output unit 133 sets the angular threshold to a value greater than a value to be set when there is an object. In this manner, the output unit 133 sets the angular threshold in accordance with whether there is an object related to audio information, the user can more easily understand the content of the output audio information.

If the position indicated by the position information of the user terminal 110 and the position indicated by the position information of the user terminal 120 are within a predetermined distance, and if the direction information of the user terminal 120 is similar to the direction information of the user terminal 110, the output unit 133 generates sound localization information.

The output unit 133 generates sound localization information by setting a sound localization position in accordance with whether object position information has been received. If object position information has been received, the output unit 133 generates sound localization information with the position indicated by the object position information serving as a sound localization information, based on the object position information, the position information of the user terminal 120, and the direction information of the user terminal 120. Meanwhile, if no object position information has been received, the output unit 133 generates sound localization information with the position indicated by the position information of the user terminal 110 serving as a sound localization position, based on the position information of the user terminal 110, the position information of the user terminal 120, and the direction information of the user terminal 120.

In accordance with the control of the generating unit 132, the storage unit 134 stores audio information, the position information of the communication terminal 90, object position information, and region information with these pieces of information mapped together. When the region information has been changed, the storage unit 134 updates this region information to the changed region information in accordance with the control of the generating unit 132.

### <Operation Example of Server Device>

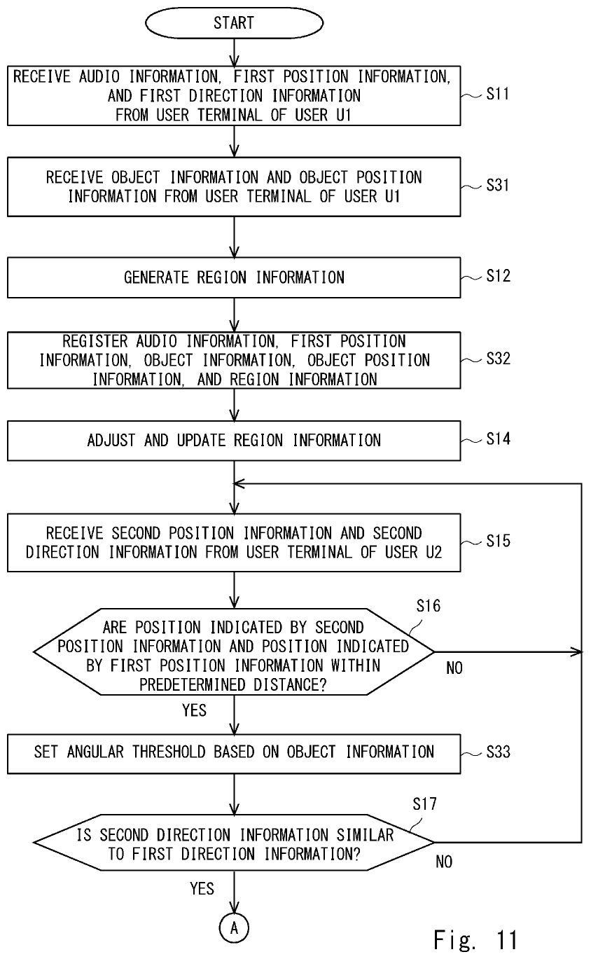

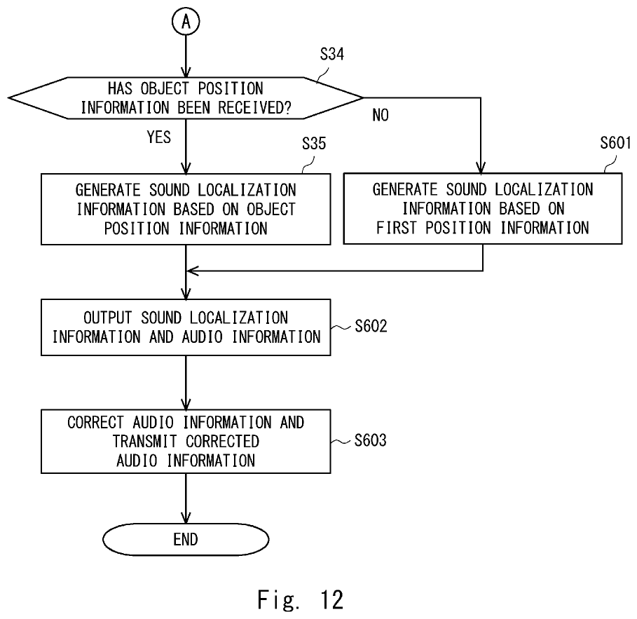

Next, an operation example of the server device 130 according to the fifth example embodiment will be described with reference to FIGS. 11 and 12. FIGS. 11 and 12 show a flowchart illustrating an operation example of the server device according to the fifth example embodiment. FIGS. 11 and 12 correspond to FIG. 8, and in FIGS. 11 and 12, steps S31 to S35 are added to the operation shown in FIG. 8. Steps S11 to S17 and steps S601 to S603 shown in FIGS. 9 and 10 are basically similar to those shown in FIG. 8, and thus description thereof will be omitted, as appropriate.

In the flowchart shown in FIGS. 11 and 12, operations up to step S14 are executed as an audio information registration process, and operations at step S15 and thereafter are executed as an audio information output process. As with FIG. 8, the audio information registration process is executed when a registration instruction for audio information has been received from the user terminal 110, and the audio information output process is executed repeatedly each time the server device 130 acquires the position information and the direction information of the user terminal 120.

For the sake of facilitating description, in FIGS. 11 and 12 as well, the position information of the user terminal 110 is referred to as first position information, and the direction information of the user terminal 110 is referred to as first direction information. Meanwhile, the position information of the user terminal 120 is referred to as second position information, and the direction information of the user terminal 120 is referred to as second direction information.

The receiving unit 131 receives object information and object position information from the user terminal 110 of the user U1 (step S31). Herein, if the object-related information generating unit 91 generates no object position information, the receiving unit 131 does not receive any object position information.

The generating unit 132 generates region information with the position indicated by the first position information serving as a reference (step S12), and registers, into the storage unit 134, the generated region information mapped to the position information of the user terminal 110, the object information, the object position information, and the audio information (step S32).

The receiving unit 131 receives second position information and second direction information from the user terminal 120 of the user U2 (step S15), and the output unit 133 determines whether the position indicated by the first position information and the position indicated by the second position information are within a predetermined distance (step S16).

If the position indicated by the first position information and the position indicated by the second position information are within the predetermined distance (YES at step S16), the output unit 133 sets an angular threshold based on the object information (step S33). The output unit 133 sets the angular threshold to a first angular threshold if the object information indicates that there is an object related to the audio information or sets the angular threshold to a second angular threshold greater than the first angular threshold if the object information indicates that there is no object related to the audio information.

The output unit 133 determines whether the second direction information is similar to the first direction information with use of the angular threshold set at step S33 (step S17).

If the second direction information is similar to the first direction information (YES at step S17), the output unit 133 determines whether object position information has been received (step S34).

If the object position information has been received (YES at step S34), the output unit 133 generates sound localization information based on the object position information (step S35). If the object position information has been received, the output unit 133 generates sound localization information with the position indicated by the object position information serving as a sound localization information, based on the object position information, the second position information, and the second direction information.

Meanwhile, if no object position information has been received (NO at step S34), the output unit 133 generates sound localization information that is based on the first position information (step S601). If no object position information has been received, the output unit 133 generates sound localization information with the position indicated by the first position information serving as a sound localization information, based on the first position information, the second position information, and the second direction information.

The output unit 133 outputs the sound localization information and the position information of the user terminal 110 to the control unit 64 (step S602), and the control unit 64 corrects the audio information and transmits the corrected audio information to the user terminal 120 (communication terminal 40) (step S603).

As described above, even when the third and fourth example embodiments are modified as in the fifth example embodiment, advantageous effects similar to those provided by the third and fourth example embodiments can be obtained. According to the fifth example embodiment, the user U1 can virtually install audio information to an object, and the user U2 can listen to the audio information as if the object is talking to the user U2. Accordingly, the fifth example embodiment can provide a user with a virtual experience that the user cannot experience in meatspace.

### Modification Example 1

According to the fifth example embodiment, the output unit 133 determines whether there is an object related to audio information based on object information. Alternatively, the output unit 133 may determine whether where is an object based on the position information of the user terminal 110 and the direction information of the user terminal 110.

In this case, the object-related information generating unit 91 does not generate object information, but generate object position information if audio information is to be installed virtually to an object. The output unit 133 may determine whether there is an object based on the amount of change in the position information of the user terminal 110 and the amount of change in the direction information of the user terminal 110. The output unit 133 may determine that there is an object at least one of if the amount of change in the position information of the user terminal 110 is no greater than a predetermined value or if the amount of change in the direction information of the user terminal 110 is no greater than a predetermined value.

When the user U1 records his or her feelings or the like on an object while facing the object, the user U1 presumably records them while looking at the object. Therefore, the output unit 133 determines whether the user U1 continuously faces the same direction without moving to another position, based on the position information of the user terminal 110 and the direction information of the user terminal 110. Then, if the user U1 continuously faces the same direction without moving to another position, the output unit 133 determines that the user U1 is recording his or her feelings or the like on an object while facing the object. Herein, the amount of change in the position information of the user terminal 110 and the amount of change in the direction information of the user terminal 110 may be an amount of change observed from when the user terminal 110 has started generating audio information to when the user terminal 110 has finished generating the audio information or may be an amount of change observed from immediately before the user terminal 110 has started generating audio information to when the user terminal 110 has finished generating the audio information.

### Modification Example 2

In the fifth example embodiment, the output unit 133 may determine whether there is an object based on the position information of the user terminal 110, the direction information of the user terminal 110, and past history information. The history information may be a database having registered and associated therein position information received from a plurality of users in the past, direction information received from the plurality of users in the past, and information regarding objects mapped to such position information and direction information, and this history information is stored in the storage unit 134. The output unit 133 may determine whether there is an object related to audio information based on the position information of the user terminal 110, the direction information of the user terminal 110, and the history information.

The output unit 133 may calculate the degree of similarity between the position information and direction information of the user terminal 110 and the position information and direction information included in the history information and may determine whether there is an object based on object information with a record of a high degree of similarity. The output unit 133 may determine that there is an object if the object information with a record of the highest degree of similarity indicates that there is an object. Alternatively, the output unit 133 may determine that there is an object if, of the records each having a degree of similarity no lower than a predetermined value, the number of pieces of object information that indicates that there is an object is no lower than a predetermined number.

### Modification Example 3

In the fifth example embodiment, the output unit 133 may output audio information if object position information has been received and if the user U2 is facing the direction of the corresponding object, and may generate sound localization information with the position indicated by the object position information serving as a sound localization position. The output unit 133 may perform the following, in addition to making a determination based on the position information of the user terminal 110, the position information of the user terminal 120, the direction information of the user terminal 120, and the direction information of the user terminal 110.

If object position information has been received, if region information encompasses the position information of the user terminal 120, and if the position indicated by the object position information is in the direction indicated by the direction information of the user terminal 120, the output unit 133 may generate sound localization information with the position of the object serving as a sound localization position. Then, the output unit 133 may output the sound localization information in which the position of the object serves as the sound localization position and the audio information to the control unit 64, and the control unit 64 may transmit the audio information corrected based on the sound localization information to the communication terminal 40.

Alternatively, if object position information has been received, if region information encompasses the position information of the user terminal 120, and if the position indicated by the object position information is in the direction indicated by the direction information of the user terminal 120, the output unit 133 may output only the audio information to the control unit 64. Then, the control unit 64 may transmit the audio information that is not subjected to a sound localization process to the communication terminal 40.

This configuration makes it possible to output audio information to the user U2 when the user U2 is looking at an object related to audio information of the user U1, and thus the user U2 can further understand the content of the audio information.

### Modification Example 4

In the fifth example embodiment, the control unit 64 may allow the user U2 to browse installation position information indicating an installation position to which the user U1 has virtually installed audio information. In this case, the receiving unit 131 receives a browse request for browsing the installation position information from the user terminal 120. The storage unit 134 stores an installation position information table. If object position information is received from the user terminal 110, the generating unit 132 stores the object position information into the installation position information table as installation position information. If no object position information is received from the user terminal 110, the generating unit 132 stores the position information of the user terminal 110 into the installation position information table as installation position information. The control unit 64 transmits installation position information set in the installation position information table to the user terminal 120.

The control unit 64 may turn the installation position information into a list and transmit list information of this list to the user terminal 120. Herein, the storage unit 134 may, for example, store a database in which names of spots, such as a tourist spot, and their position information are mapped to each other, and if the control unit 64 has been able to acquire the name of a spot corresponding to object position information from this database, the control unit 64 may incorporate the name of this spot into the list.

The control unit 64 may superpose installation position information onto map information and transmit this map information superposed with the installation position information to the user terminal 120. The user terminal 120 is configured to include a display, and the user terminal 120 displays the installation position information on the display.

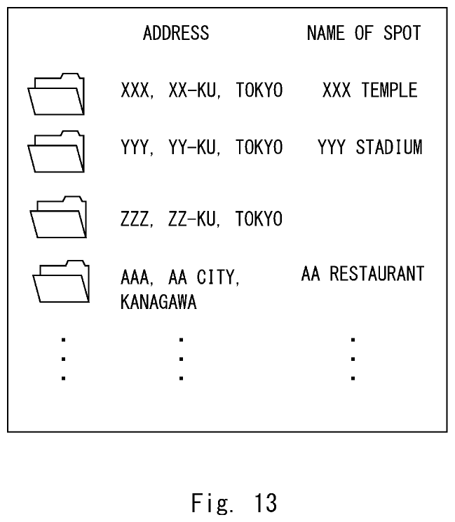

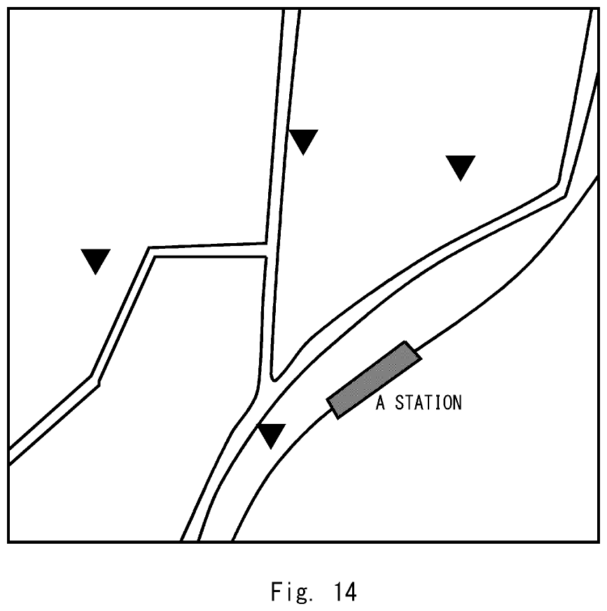

FIGS. 13 and 14 show examples of how installation position information is displayed. FIG. 13 shows an example of how list information in which installation position information is turned into a list is displayed. List information includes, for example, addresses and names of spots, and the user terminal 120 displays the addresses and the names of spots included in the list information in order of proximity to the position indicated by the position information of the user terminal 120.

FIG. 14 shows an example of how map information superposed with installation position information is displayed. The user terminal 120, for example, displays map information in which installation position information is plotted by a triangle symbol, with the position indicated by the position information of the user terminal 120 serving as a center position. With Modification Example 5 of the fifth example embodiment, the user U2 can visit an installation position to which the user U1 has virtually installed audio information and share the information with the user U1. Moreover, if the user U1 incorporates information indicating the next spot into audio information, the user U1 can guide the user U2 to the next spot.

Herein, the generating unit 62 may incorporate, in addition to installation position information, the registration date and time at which each installation position information has been registered or the registration order, and the control unit 64 may transmit, in addition to the installation position information, the registration date and time or the registration order to the user terminal 120. This configuration makes it possible to guide the user U2 to the positions to which audio information has been virtually installed in the order in which the user U1 has visited these positions, based on the registration date and time and the registration order.

### Modification Example 5

In the description of the fifth example embodiment, object position information is acquired if there is an object related to audio information, but whether there actually is an object is not to be equated with whether there is object position information. Therefore, in one conceivable case, for example, the user U1 issues a registration instruction for audio information while facing an object, but no object information position information is acquired. Therefore, the server device 130 may be configured to output monaural audio to the communication terminal 40 if the server device 130 has determined that the user U2 is facing the direction that the user U1 is facing.

Specifically, the output unit 133 determines whether the position information of the user terminal 120 is encompassed by region information and whether the angle formed by the direction indicated by the direction information of the user terminal 110 and the direction indicated by the direction information of the user terminal 120 is no greater than an angular threshold. The output unit 133 may be configured to transmit audio information that the receiving unit 61 has received to the communication terminal 40 via the control unit 64, without generating sound localization information, if the above determination condition is satisfied.

### Sixth Example Embodiment

A sixth example embodiment is an improvement example of the third to fifth example embodiments. Therefore, the sixth example embodiment will be described based on the third example embodiment in regard to its differences from the third example embodiment. Prior to describing the details of the sixth example embodiment, an outline of the sixth example embodiment will be described.

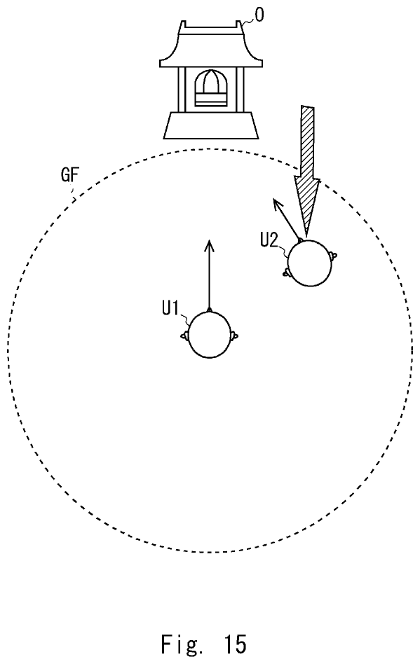

FIG. 15 is an illustration for describing an outline of the sixth example embodiment. In FIG. 15, the dotted line represents a geofence GF, the solid arrows represent the respective directions indicated by the direction information of the user U1 and of the user U2, and the arrow with hatching represents the moving direction of the user U2. The user U1 may, for example, generate audio information while facing the direction of an object O, such as a piece of architecture, and issue a registration instruction for the audio information. Then, the user U2 may move away from the object O in the direction indicated by the arrow and enter the geofence GF. In one conceivable case, the user U2 may momentarily glance at the direction that the user U1 is facing, upon entering the geofence GF. In this case, even though the user U2 is facing the direction that the user U1 is facing, when the moving direction is considered, the user U2 is likely to soon turn to the direction of the moving direction. Therefore, according to the present example embodiment, audio information is output to the user U2 with the moving direction of the user U2 held when the user U2 has entered the geofence GF taken into consideration.

### <Configuration Example of Information Processing System>

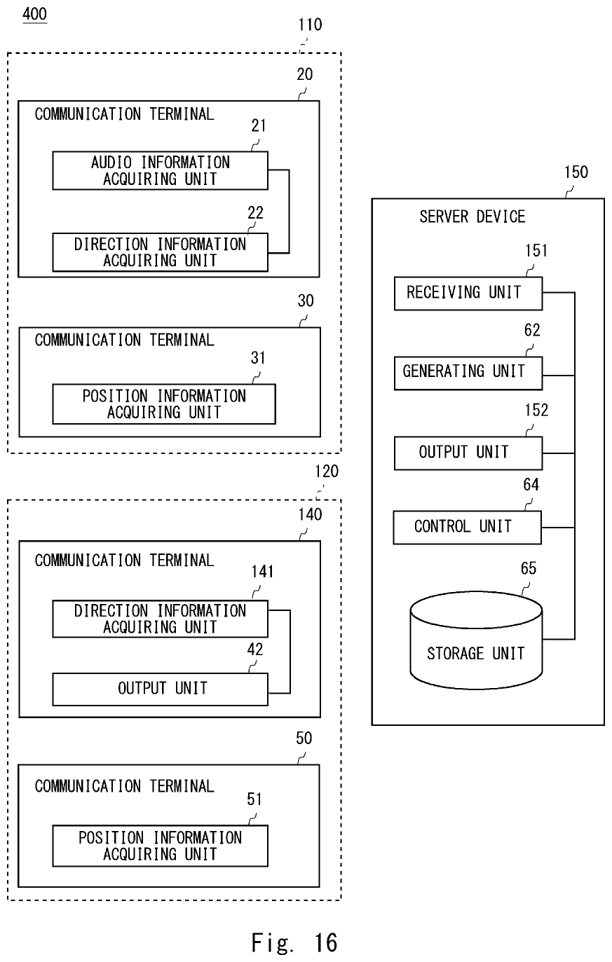

An information processing system 400 according to the sixth example embodiment will be described with reference to FIG. 16. FIG. 16 illustrates a configuration example of the information processing system according to the sixth example embodiment. The information processing system 400 includes a user terminal 110, a user terminal 120, and a server device 150. The user terminal 110 includes communication terminals 20 and 30. The user terminal 120 includes communication terminals 140 and 50.

The information processing system 400 has a configuration in which the communication terminal 40 according to the third example embodiment is replaced with the communication terminal 140 and the server device 60 is replaced with the server device 150. Configuration examples and operation examples of the communication terminals 20, 30, and 50 are basically similar to those according to the third example embodiment, and thus description thereof will be omitted, as appropriate.

### <Configuration Example of Communication Terminal>

Next, a configuration example of the communication terminal 140 will be described. The communication terminal 140 includes a direction information acquiring unit 141 and an output unit 42. The communication terminal 140 has a configuration in which the direction information acquiring unit 41 according to the third example embodiment is replaced with the direction information acquiring unit 141. The configuration of the output unit 42 is basically similar to that according to the second example embodiment, and thus description thereof will be omitted, as appropriate.

The direction information acquiring unit 141 acquires, in addition to the direction information of the communication terminal 140, moving direction information about the moving direction of the communication terminal 140. The direction information acquiring unit 141 includes a 9-axis sensor, and thus the direction information acquiring unit 141 can acquire the moving direction information of the communication terminal 140 as well. The direction information acquiring unit 141 acquires the moving direction information periodically or non-periodically. The direction information acquiring unit 141 transmits the acquired moving direction information to the server device 150.

### <Configuration Example of Server Device>

Next, a configuration example of the server device 150 will be described. The server device 150 includes a receiving unit 151, a generating unit 62, an output unit 152, a control unit 64, and a storage unit 65. The server device 150 has a configuration in which the receiving unit 61 and the output unit 63 according to the third example embodiment are replaced with, respectively, the receiving unit 151 and the output unit 152. The generating unit 62, the control unit 64, and the storage unit 65 have configurations basically similar to the counterparts according to the third example embodiment, and thus description thereof will be omitted, as appropriate.

The receiving unit 151 receives, in addition to the information that the receiving unit 61 according to the third example embodiment receives, the moving direction information of the user terminal 120 from the user terminal 120. Specifically, the receiving unit 151 receives the moving direction information of the communication terminal 140 from the communication terminal 140. The receiving unit 151 outputs the moving direction information of the communication terminal 140 to the output unit 152 as the moving direction information of the user terminal 120.

The output unit 152 determines the entry direction in which the user terminal 120 has entered the geofence, based on the moving direction information of the user terminal 120. The output unit 152 determines whether the angle formed by the determined entry direction and the direction indicated by the direction information of the user terminal 110 is within a predetermined angular range and/or within an entry angular threshold. The predetermined angular range may be, for example, any angle of from 0° to 90°. Meanwhile, the entry angular threshold may be, for example, 90° including, when the moving direction of the user terminal 110 held immediately before a registration instruction for audio information has been issued is due east, 45° to the north and 45° to the south of that moving direction. In other words, the entry angular threshold may be an angle that, when the moving direction of the user terminal 110 is presumed to be 0°, includes the range of from −45° to +45° of the moving direction.

The output unit 152 determines the direction indicated by the moving direction information of the user terminal 120 held when the position information of the user terminal 120 has become encompassed by region information as the entry direction in which the user terminal 120 has entered the geofence. The output unit 152 calculates the angle formed by the entry direction and the direction indicated by the direction information of the user terminal 110. If the calculated angle is within a predetermined angular range, the output unit 152 outputs sound localization information in which the position indicated by the position information of the user terminal 110 serves as a sound localization position. Herein, the output unit 152 may calculate the angle formed by a reference direction and the direction indicated by the moving direction information and determine whether the difference between the calculated angle and an angle θ1 is within a predetermined angular range. Determining the entry direction in which the communication terminal 140 has entered the geofence may be rephrased as determining the entry direction into the geofence. Therefore, it can be said that the output unit 152 determines whether the difference between the entry angle at which the communication terminal 140 has entered the geofence and the angle θ1 is within a predetermined angular range.

### <Operation Example of Server Device>

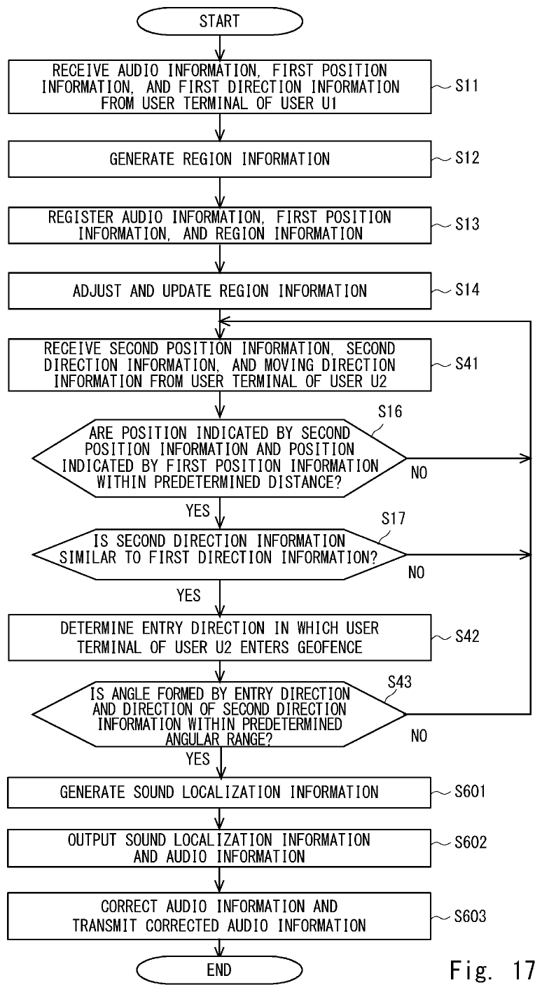

Next, an operation example of the server device 150 according to the sixth example embodiment will be described with reference to FIG. 17. FIG. 17 is a flowchart illustrating an operation example of the server device according to the sixth example embodiment. FIG. 17 corresponds to FIG. 8, and FIG. 17 shows a flowchart in which step S15 of FIG. 8 is replaced with step S41 and steps S42 and S43 are added. Steps S11 to S14, S16, S17 and steps S601 to S603 are basically similar to those shown in FIG. 8, and thus description thereof will be omitted, as appropriate.

The receiving unit 151 receives second position information, second direction information, and moving direction information from the user terminal 120 of the user U2 (step S41). The receiving unit 151 receives the direction information and the moving direction information of the communication terminal 140 from the communication terminal 140 and receives the position information of the communication terminal 50 from the communication terminal 50. The receiving unit 151 outputs the direction information and the moving direction information of the communication terminal 140 to the output unit 152 as the direction information and the moving direction information of the user terminal 120. The receiving unit 151 outputs the position information of the communication terminal 50 to the output unit 152 as the position information of the user terminal 120.

At step S17, if it has been determined that the second direction information is similar to the first direction information (YES at step S17), the output unit 152 determines the entry direction in which the user terminal 120 has entered the geofence (step S42). The output unit 152 determines the direction indicated by the moving direction information of the user terminal 120 held when the position information of the user terminal 120 has become encompassed by the region information as the entry direction in which the user terminal 120 has entered the geofence.

The output unit 152 determines whether the angle formed by the entry direction and the direction indicated by the second direction information is within a predetermined angular range (step S43). The output unit 152 calculates the angle formed by the determined entry direction and the direction indicated by the direction information of the communication terminal 20. The output unit 152 determines whether the calculated angle is within a predetermined angular range.

If the angle formed by the entry direction and the direction indicated by the second direction information is within the predetermined angular range (YES at step S43), the output unit 152 outputs sound localization information in which the position indicated by the position information of the user terminal 110 serves as a sound localization position (step S601).

Meanwhile, if the angle formed by the entry direction and the direction indicated by the second direction information is not within the predetermined angular range (NO at step S43), the server device 150 returns to step S41 and executes step S41 and the steps thereafter. Herein, if the user terminal 120 has entered the geofence but has not exited the geofence, steps S42 and S43 do not need to be executed again.

As described above, even when the configuration of the third to fifth example embodiments is configured as in the sixth example embodiment, advantageous effects similar to those provided by the third to fifth example embodiments can be obtained. Furthermore, the configuration according to the sixth example embodiment makes it possible to output audio information to the user U2 with the moving direction of the user U2 held when the user U2 has entered the geofence GF taken into consideration. Therefore, the information processing system 400 according to the sixth example embodiment allows the user U2 to listen to audio information when the user U2 is continuously facing the direction that the user U1 is facing. Accordingly, the information processing system 400 according to the sixth example embodiment can output audio information to the user U2 at an appropriate timing. With this configuration, the user U2 can sympathize with the audio information that the user U1 has registered and can, moreover, acquire new information from the audio information that the user U1 has shared.

### Modification Example 1

According to the sixth example embodiment, the output unit 152 determines the entry direction in which the user terminal 120 has entered the geofence, with use of the moving direction information of the user terminal 120. Alternatively, the output unit 152 may determine the entry direction with use of the position information of the user terminal 120. The output unit 152 may determine the entry direction in which the user terminal 120 has entered the geofence, based on the position information held immediately before the position information of the user terminal 120 has become encompassed by region information and the position information held immediately after the position information of the user terminal 120 has become encompassed by the region information. Even when the sixth example embodiment is modified as in this modification example, advantageous effects similar to those provided by the fifth example embodiment can be obtained. Herein, the sixth example embodiment and the present modification example may be combined. The output unit 152 may determine, as the final entry direction, for example, any direction between the entry direction that is based on the moving direction information of the user terminal 120 and the entry direction that is based on the position information of the user terminal 120.

### Modification Example 2

In the sixth example embodiment, the position information acquiring unit 31 may acquire the position information of the communication terminal 30 periodically either before and after the user U1 inputs a registration instruction for audio information or thereafter, and the moving direction may be based on the position information of the communication terminal 30 that the position information acquiring unit 31 transmits to the server device 60. In other words, in a case where the user U1 records audio and where the audio information acquiring unit 21 generates audio information, the position information acquiring unit 31 acquires a plurality of pieces of position information obtained immediately before the audio information has started being generated or a plurality of pieces of position information obtained across a point of time immediately before the audio information has started being generated and a point in time immediately after the audio information has started being generated. The position information acquiring unit 31 transmits the acquired pieces of position information to the server device 60, and the server device 60 calculates the moving direction based on these pieces of position information.

Alternatively, the user terminal 110 may calculate the moving direction based on the aforementioned plurality of pieces of position information, set an entry angle into the geofence region generated based on the position information of the communication terminal 30, and transmit the entry angle to the server device 60.

In this manner, the user terminal 110 of the user U1 performs a process of obtaining the position of the user U1, the direction that the face of the user U1 is pointing, and the moving direction during an audio registration process and can thus simultaneously acquire information necessary for the server device 130 to set a geofence. Accordingly, the user U1 can place (virtually install) audio information more simply.

### Modification Example 3

In the sixth example embodiment, the output unit 152 generates sound localization information if the angle formed by the entry direction and the direction indicated by the direction information of the user terminal 110 is within a predetermined angular range. Alternatively, the output unit 152 may be configured to transmit monaural audio via the control unit 64, without generating sound localization information. Specifically, the output unit 152 may be configured to transmit audio information that the receiving unit 61 has received to the communication terminal 40 via the control unit 64, without generating sound localization information, if the angle formed by the entry direction and the direction indicated by the direction information of the user terminal 110 is within a predetermined angular range.

### Other Example Embodiments

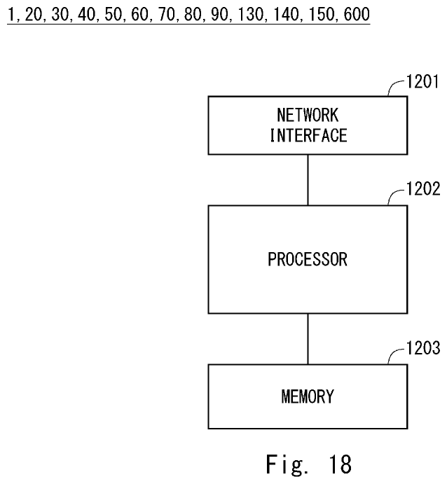

FIG. 18 illustrates a hardware configuration example of the information processing device 1, the communication terminals 20, 30, 40, 50, 70, 90, and 140, and the server devices 60, 80, 130, 150, and 600 (these are referred to below as the information processing device 1 and others) described according to the foregoing example embodiments. With reference to FIG. 18, the information processing device 1 and others each include a network interface 1201, a processor 1202, and a memory 1203. The network interface 1201 is used to communicate with another device included the information processing system.

The processor 1202 reads out software (computer program) from the memory 1203 and executes the software. Thus, the processor 1202 implements the processes of the information processing device 1 and others described with reference to the flowcharts according to the foregoing example embodiments. The processor 1202 may be, for example, a microprocessor, a micro processing unit (MPU), or a central processing unit (CPU). The processor 1202 may include a plurality of processors.

The memory 1203 is constituted by a combination of a volatile memory and a non-volatile memory. The memory 1203 may include a storage provided apart from the processor 1202. In this case, the processor 1202 may access the memory 1203 via an I/O interface (not illustrated).

In the example illustrated in FIG. 18, the memory 1203 is used to store a set of software modules. The processor 1202 can read out this set of software modules from the memory 1203 and execute this set of software modules. Thus, the processor 1202 can perform the processes of the information processing device 1 and others described according to the foregoing example embodiments.

As described with reference to FIG. 18, each of the processors in the information processing device 1 and others executes one or more programs including a set of instructions for causing a computer to execute the algorithms described with reference to the drawings.

In the foregoing examples, a program can be stored and provided to a computer by use of various types of non-transitory computer-readable media. Non-transitory computer-readable media include various types of tangible storage media. Examples of such non-transitory computer-readable media include a magnetic storage medium (e.g., flexible disk, magnetic tape, hard-disk drive), a magneto-optical storage medium (e.g., magneto-optical disk). Additional examples of such non-transitory computer-readable media include a CD-ROM (read-only memory), a CD-R, and a CD-R/W. Yet additional examples of such non-transitory computer-readable media include a semiconductor memory. Examples of semiconductor memories include a mask ROM, a programmable ROM (PROM), an erasable PROM (EPROM), a flash ROM, or a random-access memory (RAM). A program may be supplied to a computer also by use of various types of transitory computer-readable media. Examples of such transitory computer-readable media include an electric signal, an optical signal, and an electromagnetic wave. A transitory computer-readable medium can supply a program to a computer via a wired communication line, such as an electric wire or an optical fiber, or via a wireless communication line.

It is to be noted that the present disclosure is not limited to the foregoing example embodiments, and modifications can be made, as appropriate, within the scope that does not depart from the technical spirit. The present disclosure may be implemented by combining the example embodiments, as appropriate.

A part or the whole of the foregoing example embodiments can also be expressed as in the following supplementary notes, which are not limiting.

(Supplementary Note 1)

An information processing device comprising:

receiving means configured to receive audio information, first position information of a first user terminal, and first direction information of the first user terminal from the first user terminal, and receive second position information of a second user terminal and second direction information of the second user terminal from the second user terminal; and

output means configured to output the audio information, if a first position indicated by the first position information and a second position indicated by the second position information are within a predetermined distance, and if the second direction information is similar to the first direction information.

(Supplementary Note 2)

The information processing device according to Supplementary Note 1, further comprising generating means configured to generate region information that specifies a region for which the first position serves as a reference,

wherein the output means is configured to output the audio information, if the region information encompasses the second position information, and if an angle formed by a direction indicated by the first direction information and a direction indicated by the second direction information is no greater than an angular threshold.

(Supplementary Note 3)

The information processing device according to Supplementary Note 2, wherein

the output means is configured to generate sound localization information for which the first position serves as a sound localization position, based on the first position information, the second position information, and the second direction information, and further output the sound localization information.

(Supplementary Note 4)

The information processing device according to Supplementary Note 2 or 3, wherein

the receiving means is configured to, if the audio information is installed virtually in an object related to the audio information, receive object position information indicating position information of the object from the first user terminal, and

the output means is configured to output the audio information, if the object position information has been received, if the region information encompasses the second position information, and if a position indicated by the object position information is in a direction indicated by the second direction information for which the second position information serves as a reference.

(Supplementary Note 5)

The information processing device according to Supplementary Note 4, wherein the output means is configured to generate sound localization information for which a position of the object serves as a sound localization position, if the object position information has been received, if the region information encompasses the second position information, and if the position indicated by the object position information is in the direction indicated by the second direction information for which the second position information serves as a reference.

(Supplementary Note 6)

The information processing device according to any one of Supplementary Notes 2 to 5, wherein

the receiving means is configured to, if the audio information is installed virtually in an object related to the audio information, receive object position information indicating position information of the object from the first user terminal, and

the output means is configured to generate sound localization information for which a position of the object serves as a sound localization position based on the object position information, the second position information, and the second direction information, if the object position information has been received.

(Supplementary Note 7)

The information processing device according to Supplementary Note 3, 5, or 6, wherein the output means is configured to transmit the audio information and the sound localization information to the second user terminal.

(Supplementary Note 8)

The information processing device according to Supplementary Note 3, 5, or 6, further comprising control means configured to subject the audio information to a sound localization process based on the audio information and the sound localization information, and transmit the audio information subjected to the sound localization process to the second user terminal.

(Supplementary Note 9)

The information processing device according to Supplementary Note 8, wherein

the receiving means is configured to, if the audio information is installed virtually in an object related to the audio information, receive object position information of the object from the first user terminal, and receive a browse request for installation position information as to where the audio information is virtually installed from the second user terminal,

the information processing device further comprising generating means configured to register the object position information into storage means as the installation position information if the object position information has been received, or register the first position information into the storage means as the installation position information if the object position information has not been received, and

the control means is configured to transmit installation position information registered in the storage means to the second user terminal.

(Supplementary Note 10)

The information processing device according to any one of Supplementary Notes 2 to 9, wherein the output means is configured to set the angular threshold if an object related to the audio is present.

(Supplementary Note 11)

The information processing device according to Supplementary Note 10, wherein the output means is configured to set the angular threshold to a first angular threshold if the object is present or set the angular threshold to a second angular threshold greater than the first angular threshold if the object is not present.

(Supplementary Note 12)

The information processing device according to Supplementary Note 10 or 11, wherein the output means is configured to determine if the object is present based on at least one of an amount of change in the first position information or an amount of change in the first direction information.

(Supplementary Note 13)

The information processing device according to any one of Supplementary Notes 10 to 12, further comprising storage means configured to store history information in which third position information received from a plurality of users, third direction information received from the plurality of users, and information regarding an object mapped to the third position information and the third direction information are associated and registered, wherein the output means is configured to determine if the object is present based on the first position information, the first direction information, and the history information.

(Supplementary Note 14)

The information processing device according to any one of Supplementary Notes 2 to 13, wherein the generating means is configured to determine a moving state of the first user terminal based on an amount of change in the first position information, and adjust the generated region information based on the determined moving state.

(Supplementary Note 15)

The information processing device according to any one of Supplementary Notes 2 to 14, wherein

the receiving means is configured to receive speed information of the first user terminal, and

the generating means is configured to determine a moving state of the first user terminal based on the speed information, and adjust the generated region information based on the determined moving state.

(Supplementary Note 16)

The information processing device according to Supplementary Note 14 or 15, wherein

the moving state includes a stationary state, and

the generating means is configured to change the generated region information to region information specifying a region that is based on the first position, if the determined moving state is the stationary state.

(Supplementary Note 17)

The information processing device according to any one of Supplementary Notes 14 to 16, wherein

the moving state includes a walking state and a running state, and

the generating means is configured to change the generated region information to region information specifying a region that is based on first position information held when generation of the audio information has started and first position information held when generation of the audio information has finished, if the determined moving state is the walking state or the running state.

(Supplementary Note 18)

The information processing device according to any one of Supplementary Notes 2 to 17, wherein

the receiving means is configured to further receive moving direction information of the second user terminal, and

the output means is configured to determine an entry direction in which the second user terminal has entered the region, based on the moving direction information, and output the audio information if an angle formed by the entry direction and the direction indicated by the first direction information is within a predetermined angular range.

(Supplementary Note 19)

The information processing device according to any one of Supplementary Notes 2 to 18, wherein the output means is configured to determine an entry direction in which the second user terminal has entered the region, based on the second position information, and output the audio information if an angle formed by the entry direction and the direction indicated by the first direction information is within a predetermined angular range.

(Supplementary Note 20)

The information processing device according to any one of Supplementary Notes 1 to 19, wherein the output means is configured to determine whether to output the audio information, based on first attribute information of a first user who uses the first user terminal and second attribute information of a second user who uses the second user terminal.

(Supplementary Note 21)

A user terminal, wherein the user terminal is configured to:

acquire audio information and position information of the user terminal; and

in response to receiving a registration instruction for the audio information, transmit the acquired audio information, the acquired position information, and the acquired direction information to an information processing device.

(Supplementary Note 22)

The user terminal according to Supplementary Note 21, wherein the user terminal is configured to, in response to receiving the registration instruction, acquire direction information of the user terminal based on an acquired result obtained by measuring a posture of a user who uses the user terminal, and then transmit the result of the measurement, along with the audio information, to the information processing device.

(Supplementary Note 23)

The user terminal according to Supplementary Note 21 or 22, wherein the user terminal is configured to, in response to receiving the registration instruction, further transmit, to the information processing device, position information of the user terminal held before receiving the registration instruction or position information of the user terminal held before and after receiving the registration instruction.

(Supplementary Note 24)

A control method comprising:

receiving audio information, first position information of a first user terminal, and first direction information of the first user terminal from the first user terminal;

receiving second position information of a second user terminal and second direction information of the second user terminal from the second user terminal; and

outputting the audio information based on the first position information, the second position information, and the second direction information, if a first position indicated by the first position information and a second position indicated by the second position information are within a predetermined distance of each other, and if the second direction information is similar to the first direction information.

(Supplementary Note 25)

A non-transitory computer-readable medium storing a control program that causes a computer to execute the processes of:

receiving audio information, first position information of a first user terminal, and first direction information of the first user terminal from the first user terminal;

receiving second position information of a second user terminal and second direction information of the second user terminal from the second user terminal; and

outputting the audio information, if a first position indicated by the first position information and a second position indicated by the second position information are within a predetermined distance of each other, and if the second direction information is similar to the first direction information.

(Supplementary Note 26)

An information processing system comprising:

a first user terminal;

a second user terminal; and

a server device configured to communicate with the first user terminal and the second user terminal, wherein

the first user terminal is configured to acquire audio information, first position information of the first user terminal, and first direction information of the first user terminal,

the second user terminal is configured to acquire second position information of the second user terminal and second direction information of the second user terminal, and

the server device is configured to
receive the audio information, the first position information, and the first direction information from the first user terminal,
receive the second position information and the second direction information from the second user terminal, and
output the audio information, if a first position indicated by the first position information and a second position indicated by the second position information are within a predetermined distance of each other, and if the second direction information is similar to the first direction information.

(Supplementary Note 27)

The information processing system according to Supplementary Note 26, wherein the server device is configured to

generate region information that specifies a region for which the first position information serves as a reference, and

output the audio information, if the region information encompasses the second position information, and if an angle formed by a direction indicated by the first direction information and a direction indicated by the second direction information is within an angular threshold.

### REFERENCE SIGNS LIST

1 INFORMATION PROCESSING DEVICE
2, 61, 131, 151 RECEIVING UNIT
3, 42, 63, 81, 133, 152, 631 OUTPUT UNIT
20, 30, 40, 50, 70, 90, 140 COMMUNICATION TERMINAL
21 AUDIO INFORMATION ACQUIRING UNIT
22, 41, 141 DIRECTION INFORMATION ACQUIRING UNIT
31, 51 POSITION INFORMATION ACQUIRING UNIT
60, 80, 130, 150, 600 SERVER DEVICE
62, 132 GENERATING UNIT
64, 71, 641 CONTROL UNIT
65, 134 STORAGE UNIT
91 OBJECT-RELATED INFORMATION GENERATING UNIT
10, 200, 300, 400, 1000 INFORMATION PROCESSING SYSTEM
110, 120 USER TERMINAL

What is claimed is:

1. An information processing device comprising:
at least one memory storing instructions, and
at least one processor configured to execute the instructions to:
receive audio information, first position information of a first user terminal, and first direction information of the first user terminal from the first user terminal, and receive second position information of a second user terminal and second direction information of the second user terminal from the second user terminal; and
output the audio information, if a first position indicated by the first position information and a second position indicated by the second position information are within a predetermined distance, and if the second direction information is similar to the first direction information.

2. The information processing device according to claim 1, wherein the at least one processor is further configured to execute the instructions to:
generate region information that specifies a region for which the first position serves as a reference, and
output the audio information, if the region information encompasses the second position information, and if an angle formed by a direction indicated by the first direction information and a direction indicated by the second direction information is no greater than an angular threshold.

3. The information processing device according to claim 2, wherein the at least one processor is further configured to execute the instructions to generate sound localization information for which the first position serves as a sound localization position, based on the first position information, the second position information, and the second direction information, and further output the sound localization information.

4. The information processing device according to claim 2, wherein the at least one processor is further configured to execute the instructions to:
if the audio information is installed virtually in an object related to the audio information, receive object position information indicating position information of the object from the first user terminal, and
output the audio information, if the object position information has been received, if the region information encompasses the second position information, and if a position indicated by the object position information is in a direction indicated by the second direction information for which the second position information serves as a reference.

5. The information processing device according to claim 4, wherein the at least one processor is further configured to execute the instructions to generate sound localization information for which a position of the object serves as a sound localization position, if the object position information has been received, if the region information encompasses the second position information, and if the position indicated by the object position information is in the direction indicated by the second direction information for which the second position information serves as a reference.

6. The information processing device according to claim 2, wherein the at least one processor is further configured to execute the instructions to:
if the audio information is installed virtually in an object related to the audio information, receive object position information indicating position information of the object from the first user terminal, and
generate sound localization information for which a position of the object serves as a sound localization position based on the object position information, the second position information, and the second direction information, if the object position information has been received.

7. The information processing device according to claim 3, wherein the at least one processor is further configured to execute the instructions to transmit the audio information and the sound localization information to the second user terminal.

8. The information processing device according to claim 3, wherein the at least one processor is further configured to execute the instructions to subject the audio information to a sound localization process based on the audio information and the sound localization information, and transmit the audio information subjected to the sound localization process to the second user terminal.

9. The information processing device according to claim 8, wherein the at least one processor is further configured to execute the instructions to:
if the audio information is installed virtually in an object related to the audio information, receive object position information of the object from the first user terminal, and receive a browse request for installation position information as to where the audio information is virtually installed from the second user terminal,
register the object position information into storage means as the installation position information if the object position information has been received, or register the first position information into the storage means as the installation position information if the object position information has not been received, and
transmit installation position information registered in the storage means to the second user terminal.

10. The information processing device according to claim 2, wherein the at least one processor is further configured to execute the instructions to set the angular threshold if an object related to the audio is present.

11. The information processing device according to claim 10, wherein the at least one processor is further configured to execute the instructions to set the angular threshold to a first angular threshold if the object is present or set the angular threshold to a second angular threshold greater than the first angular threshold if the object is not present.

12. The information processing device according to claim 10, wherein the at least one processor is further configured to execute the instructions to determine if the object is present based on at least one of an amount of change in the first position information or an amount of change in the first direction information.

13. The information processing device according to claim 10, wherein the at least one processor is further configured to execute the instructions to:
store history information in which third position information received from a plurality of users, third direction information received from the plurality of users, and information regarding an object mapped to the third position information and the third direction information are associated and registered, and
determine if the object is present based on the first position information, the first direction information, and the history information.

14. The information processing device according to claim 2, wherein the at least one processor is further configured to execute the instructions to determine a moving state of the first user terminal based on an amount of change in the first position information, and adjust the generated region information based on the determined moving state.

15. The information processing device according to claim 2, wherein the at least one processor is further configured to execute the instructions to:
receive speed information of the first user terminal, and
determine a moving state of the first user terminal based on the speed information, and adjust the generated region information based on the determined moving state.

16. The information processing device according to claim 14, wherein
the moving state includes a stationary state, and
the at least one processor is further configured to execute the instructions to change the generated region information to region information specifying a region that is based on the first position, if the determined moving state is the stationary state.

17. The information processing device according to claim 14, wherein
the moving state includes a walking state and a running state, and
the at least one processor is further configured to execute the instructions to change the generated region information to region information specifying a region that is based on first position information held when generation of the audio information has started and first position information held when generation of the audio information has finished, if the determined moving state is the walking state or the running state.

18. The information processing device according to claim 2, wherein the at least one processor is further configured to execute the instructions to:
further receive moving direction information of the second user terminal, and
determine an entry direction in which the second user terminal has entered the region, based on the moving direction information, and output the audio information if an angle formed by the entry direction and the direction indicated by the first direction information is within a predetermined angular range.

19. The information processing device according to claim 2, wherein the at least one processor is further configured to execute the instructions to determine an entry direction in which the second user terminal has entered the region, based on the second position information, and output the audio information if an angle formed by the entry direction and the direction indicated by the first direction information is within a predetermined angular range.

20. The information processing device according to claim 1, wherein the at least one processor is further configured to execute the instructions to determine whether to output the audio information, based on first attribute information of a first user who uses the first user terminal and second attribute information of a second user who uses the second user terminal.

21. A user terminal, wherein the user terminal is configured to:
acquire audio information and position information of the user terminal; and
in response to receiving a registration instruction for the audio information, transmit the acquired audio information, the acquired position information, and the acquired direction information to an information processing device.

22. The user terminal according to claim 21, wherein the user terminal is configured to, in response to receiving the registration instruction, acquire direction information of the user terminal based on an acquired result obtained by measuring a posture of a user who uses the user terminal, and then transmit the result of the measurement, along with the audio information, to the information processing device.

23. The user terminal according to claim 21, wherein the user terminal is configured to, in response to receiving the registration instruction, further transmit, to the information processing device, position information of the user terminal held before receiving the registration instruction or position information of the user terminal held before and after receiving the registration instruction.

24. A control method comprising:
receiving audio information, first position information of a first user terminal, and first direction information of the first user terminal from the first user terminal;
receiving second position information of a second user terminal and second direction information of the second user terminal from the second user terminal; and
outputting the audio information based on the first position information, the second position information, and the second direction information, if a first position indicated by the first position information and a second position indicated by the second position information are within a predetermined distance of each other, and if the second direction information is similar to the first direction information.

25. A non-transitory computer-readable medium storing a control program that causes a computer to execute the processes of:
receiving audio information, first position information of a first user terminal, and first direction information of the first user terminal from the first user terminal;
receiving second position information of a second user terminal and second direction information of the second user terminal from the second user terminal; and
outputting the audio information, if a first position indicated by the first position information and a second position indicated by the second position information are within a predetermined distance of each other, and if the second direction information is similar to the first direction information.

26. An information processing system comprising:
a first user terminal;
a second user terminal; and
a server device configured to communicate with the first user terminal and the second user terminal, wherein
the first user terminal is configured to acquire audio information, first position information of the first user terminal, and first direction information of the first user terminal,
the second user terminal is configured to acquire second position information of the second user terminal and second direction information of the second user terminal, and
the server device is configured to
receive the audio information, the first position information, and the first direction information from the first user terminal,
receive the second position information and the second direction information from the second user terminal, and
output the audio information, if a first position indicated by the first position information and a second position indicated by the second position information are within a predetermined distance of each other, and if the second direction information is similar to the first direction information.

27. The information processing system according to claim 26, wherein the server device is configured to
generate region information that specifies a region for which the first position information serves as a reference, and
output the audio information, if the region information encompasses the second position information, and if an angle formed by a direction indicated by the first direction information and a direction indicated by the second direction information is within an angular threshold.
